(19) United States
(12) Patent Application Publication
(10) Pub. No.: US 2021/0233134 A1
(43) Pub. Date: Jul. 29, 2021

(54) GREETING CARDS AND SYSTEM FOR CREATING AND METHODS OF MANUFACTURE AND USE

(71) Applicant: Mariu Marin, Chisinau (MD)

(72) Inventor: Mariu Marin, Chisinau (MD)

(21) Appl. No.: 16/775,973

(22) Filed: Jan. 29, 2020

(51) Int. Cl. G06Q 30/06; G09F 1/04; G06Q 20/34; G06K 19/06

(52) U.S. Cl. CPC G06Q 30/0617; G06K 19/06037; G06Q 20/351; G09F 1/04

(57) ABSTRACT

A social expression item for use in conjunction with a recipient's electronic device including a social expression item (plastic or paper postcard/gift card) having an item body; a social expression message portion located on the item body; a message printed on the social expression message portion of the item body; and a digital gift retrieval code located on the item body including instructions for accessing a remote digital storage system and a digital gift file identifier, the digital gift retrieval code being readable by a recipient's electronic device, the gift retrieval code including digital instructions which allow the recipient's electronic device to access a remote digital data storage system, the data storage system storing a digital published content (ebook, music, video) identified by the digital gift file identifier for retrieval and display of the digital gift file on the recipient's electronic device.

### BACKGROUND OF THE INVENTION

### Field of the Invention

The present invention is directed to providing an improved social expression item such as a greeting card as well as methods of ordering, manufacture, and delivery of such improved social expression items. More specifically, the present invention provides an improved social expression item that provides a readily retrievable associated digital experience.

### DESCRIPTION OF THE PRIOR ART

Currently, there are a number of systems and methods of creating custom printed gift cards or for creating customized electronic gift cards (“eCards”). One such system of ordering and manufacturing printed gift cards is described in U.S. Pat. No. 5,748,484 issued to Cannon et al. The '484 patent discloses a system of viewing, ordering, and printing greeting cards including a database preparation system, a number of card display/order systems, and a card printing system. Another system of creating and sending greeting card is disclosed in U.S. Pat. No. 7,802,386 issued to Mandelbaum et al. The '386 patent discloses a method and system for creating and distributing a paper greeting card that has an embedded digital display screen. Another system of providing an internet based greeting card is disclosed in U.S. Pat. No. 7,130,817 issued to Karas et al. The '817 patent discloses a method of creating an electronic greeting card (“eCard”) with a code embedded in the eCard which facilitates retrieving information concerning a physical gift such as where to retrieve a cash gift.

U.S. Pat. No. 9,069,770 issued to Werner et al. discloses the sale of athletic apparel, sporting goods, and shoe products, which have smart sales tags attached thereto that provide promotional and product usage digital content related to the products. The digital content of the '770 patent includes a variety of product use and promotional information such as, for example: exclusive news and information, product stats and technical information, stats and video of famous athletes that wear “Limited Edition” shoes in competition, available games, train/work out programs, and training stats tracking programs, exclusive offers, and videos on how to care for your products. As explained above, the digital content of the '770 patent is intended solely to promote usage and sale of the products sold with the smart tags system. The systems and methods of the '770 patent are not designed to convey a personal social expression message between a giver of a product or service and a recipient of that product or service.

Applicant has perceived a need to promote literacy in the current generation of international youth. The need for improved literacy appears to have developed due to many young people's over reliance of social media, electronic games and over-consumption of television and online video content at the expense of reading literature, poetry and other forms of the written arts. While electronic greeting cards have an advantage as to efficiency and ease of sending, applicant has determined that eCards are frequently viewed by recipients as having less emotional resonance than printed greeting cards or other more tangible social expression gifts. Furthermore, applicant has determined that eCards are also typically less desirable than printed cards because eCards are not considered a collectable memento similar to a written letter or a physical keepsake. Although the prior art printed gift cards provide many different ways to express personal social and emotional messages to friends, relatives, romantic interests, and/or colleagues, the applicant has perceived a need for a printed greeting card and/or tangible social expression item that provides additional novel benefits to the receiver of the card/gift.

### OBJECTS OF THE INVENTION

It is a first object of the invention to provide a printed greeting card that provides both a social greeting message as well as a retrievable digital experience component.

Another object of the invention is to provide an improved printed greeting card that accords the recipient the opportunity to quickly and efficiently retrieve a digital gift associated with the card.

One other object of the invention is to provide a method of ordering a custom printed greeting card including an associated retrievable digital gift.

A further object of the invention is to provide a method for the manufacture and distribution of an improved printed greeting card which includes a retrievable digital gift.

A further object of the invention is to provide a method for displaying a retrievable digital gift which is retrievable from an improved printed greeting card.

It is still further object of the invention to provide a system and method for ordering, manufacture, and delivery of a printed greeting card having a retrievable digital gift associated therewith.

It is still further object of the invention to provide a novel system for storage and delivery of digital gifts accessible through a printed greeting card.

It is still another object of the invention to provide a novel system for the custom design, order, manufacture, and delivery of a custom designed printed greeting card including a digital gift retrieval code.

It is another object of the invention to provide a printed greeting card that promotes literacy by providing a retrievable digital gift of a literary work.

It is another object of the invention to provide a social expression item including a retrievable digital gift associated therewith.

It is still another object of the invention to allow a social expression item giver to create a customizable social expression item, which includes access to a retrievable digital gift.

It is still another further object of the invention to provide a method for creating a social expression item which includes access to a gift recipient created digitally retrievable personal message.

### SUMMARY OF THE INVENTION

In one aspect, the invention is directed to a printed gift card having a social greeting message portion printed thereon, and a digital gift retrieval code readable by a recipient's electronic device, the gift retrieval code including digital instructions which allow the recipient to access a remote digital data storage system, the data storage system storing a digital gift encoded by the printed gift card for retrieval and display on the recipient's electronic device. The novel printed gift card optionally includes graphics, design elements, and/or photographic elements printed in the social greeting message portion. The retrievable digital gift may preferably be a literature file, a visual art file, audio file, stock audio file, stock video file, or a custom audio or video file uploaded by the card giver. Optionally, the social greeting message portion may include both a stock social expression subsection and a card giver generated personal message subsection.

Another aspect of the invention is directed to a method or ordering, manufacture and delivery a novel printed greeting card including a retrieval code for a digital gift, the method including the steps of (a) a card giver accessing a computer and directing the computer to connect with a computerized printed greeting card ordering system; (b) the computerized printed greeting card system displaying a plurality of stock greeting cards, each of the card choices having associated therewith at least one digital gift for retrieval by the gift card receiver after receipt of the card; (c) the card giver choosing at least one greeting card from the plurality of stock cards; (d) the card giver providing a delivery address for the recipient; (e) storing the recipient information, personal message, and stock card choice in memory component associated with the greeting card ordering system computer; (f) the greeting card ordering system computer having a server that sends a print command to a card printer which is electronically linked to the order system computer; (g) the card printer retrieves the recipient information, personal message, and stock card choice including the associated digital gift retrieval code; (h) printing the stock card including personal message and digital gift retrieval code; and (i) printing a delivery envelope including a delivery address retrieved from the memory of the server.

In a further aspect, the invention is directed to a method of retrieving a digital gift encoded on a printed greeting card. The method including the steps of (a) card recipient receiving a printed greeting card including a digital gift retrieval code which provides electronic access to a digital gift; (b) the card recipient causes an electronic device to read the digital gift retrieval code; (c) instructions in the digital gift retrieval code causing the electronic device to transmit an electronic signal to a website which provides access to an electronically retrievable digital gift file; (d) searching the memory component of the website for digital gift identified by the digital gift retrieval code; and (e) displaying the digital gift on the recipient's electronic device. In one preferred embodiment of the invention, the digital gift is a literary work, stock video file, or stock audio file. In another preferred embodiment of the invention, the method includes the further step of uploading a custom audio or video file created by the card giver to the memory component of the website during the process of ordering the card so that the uploaded custom file can serve as at least one of the retrievable digital gifts associated with a printed card of the invention. The machine readable digital gift retrieval code is preferably a QR code printed on the greeting card. Optionally, the method may include a further step of downloading the digital gift file to the recipient's digital device or to a separate digital device owned by the recipient.

In a still further aspect, the invention is directed to a novel social expression item object which includes (1) a social expression portion upon which a social expression message is displayed and (2) a digital gift retrieval code readable by the recipient's electronic device, the digital gift retrieval code including digital instructions which allow the recipient to access a remote digital storage system, the digital data storage system storing a digital gift encoded onto the social expression item for retrieval and display on the recipient's electronic device. In one preferred embodiment of the invention, the digital gift is a digital audio or visual file created by the giver of the gift and uploaded to and stored in the remote digital storage system.

Another aspect of the invention is directed to a method of ordering, manufacture, and delivery of a novel social expression item including a retrieval code for a digital gift. The method including the steps of (a) the social expression item giver accessing a computer and directing the computer to connect with a computerized social expression item ordering system; the computerized social expression item order system displaying a plurality of stock social expression gifts, each of the social expression gifts having associated therewith at least one digital gift for retrieval by the social expression item recipient of the receipt of the social expression gift; (c) the social expression item giver selecting at least one social expression item from the plurality of stock expression gifts; (d) the social expression item giver providing a physical delivery address for the recipient; (e) storing the social expression item selected, personal message, and recipient physical delivery address in a memory component of the social expression ordering system; (f) sending an order preparation command to an order execution computer system containing the personal message and physical delivery address information; (g) attaching the personal message and data retrieval code to the social expression item in response to the order preparation command; and (h) delivering the social expression item to the recipient at the physical delivery address.

### BRIEF DESCRIPTION OF THE DRAWINGS

FIG. 1 illustrates a block diagram of a computer networking environment for use in the systems and methods of the embodiments of the invention.

FIG. 2 shows a block diagram of a smartphone device for use in the systems and methods of multiple embodiments of the invention.

FIG. 3 is a schematic diagram illustrating a system of a recipient accessing a digital gift encoded in a social expression item.

FIG. 4 is a schematic diagram illustrating a system and method of ordering, manufacture, and retail distribution of a social expression item/card plus digital gift retrieval code in accordance with a second embodiment of the invention.

FIG. 5 is a schematic diagram illustrating an example electronic device, an example digital retrieval code on a social expression item/card, and a digital gift delivery system, and communication there between, in accordance with at least one embodiment of the invention.

FIG. 6 is a block diagram depicting the system of acquisition of QR code reader, digital gift storage, including software download and access to digital gifts.

FIG. 7 is schematic diagram illustrating an example of a social expression item in accordance with at least one embodiment of the invention.

FIG. 8 provides a flow diagram illustrating an example process of obtaining digital gift encoded by a digital gift retrieval code in accordance with at least one embodiment.

FIG. 9 is a schematic diagram of an example screenshot of a photographic image of a digital gift retrieval QR code on a recipient's electronic device.

FIG. 10 is a schematic diagram of example screenshots of a menu giving a gift recipient an option to download or view the digital gift in accordance with at least one embodiment.

FIG. 11 is a schematic diagram of gift display and download options.

FIG. 12 is a schematic diagram example of a smartphone screenshot illustrating an electronic book digital gift.

FIG. 13 is a schematic diagram showing of a smartphone screenshot displaying an example digital video gift file in accordance with at least one embodiment of the invention.

FIG. 14 is a schematic diagram showing of a smartphone screenshot displaying an example digital music gift file in accordance with at least one embodiment of the invention.

FIG. 15 is a schematic diagram showing of a smartphone screenshot displaying an example digital audiobook gift file in accordance with at least one embodiment of the invention.

FIG. 16 is a schematic diagram of computer systems used to generate digital gift files embedded in a social message gift in accordance with at least one embodiment of the invention.

FIG. 17 is a diagram of another alternative embodiment in which the item/card printing system and item/card display/order systems communicate via the Internet.

FIG. 18 is a schematic diagram of personalized physical items generation in computer system in accordance with at least one embodiment of the invention.

FIG. 19 is a schematic diagram of Data Source Components of the systems of the invention.

FIG. 20 is a schematic diagram of a computer system used in preparing social expression item/card designs by the process of this invention.

FIG. 21 is a diagrammatic view of an item/card printing system with networked item/card printing systems used for printing personalized and non-personalized social expression items/cards.

FIGS. 22A-22B show a flow chart of the overall method used in preparing databases of social expression item/card designs by the process of this invention.

FIGS. 23A and 23B are diagrammatic views of an item/card printing system used for printing personalized and non-personalized social expression items/cards.

FIG. 24 is a flow chart of the method used by this invention to configure an item/card printing system.

FIG. 25 is a diagram of the structure of the item/card description database.

FIG. 26 is a diagram of a structure of the item/card parameter database.

FIG. 27 is a diagrammatic view of an item/card display/order system where the item/card display means and the order entry and transmission means are accomplished using a personal computer system.

FIG. 28 is a diagram of components of the item/card order database and an individual order.

### DETAILED DESCRIPTION

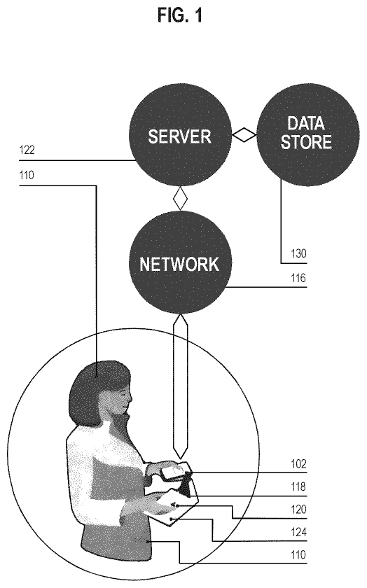

FIG. 1 illustrates an example of an environment 100 for implementing aspects in accordance with various embodiments of the systems and methods of the invention. As will be appreciated, although environment 100 is provided for purposes of explanation, alternate environments may be utilized, as appropriate, to implement various embodiments of the invention. The illustrated environment 100 includes an electronic device 102, which is any appropriate device operable to gather a digital gift retrieval code 127 to send and receive requests, messages, or information over an appropriate network 116 and convey information back to a social expression item/digital gift recipient 110 of the device 102. Examples of such electronic devices include mobile phones, electronic devices, mobile devices, handheld messaging devices, laptop computers, personal data assistants, tablet computers, electronic book readers, watches, wrist worn devices that include both communication electronics and structures capable of gathering/collecting the digital gift retrieval code 127.

In accordance with certain embodiments of the invention, the electronic device 102 incorporates the functionality of one or more portable devices, such as a cellular telephone, a media player, a personal computer, etc. The electronic device 102 must be capable of displaying text, pictures and/or video, surf the web, etc., even though the electronic device 102 is portable. The electronic device 102 should be configurable to allow a gift recipient to connect to and communicate through a network 116 (preferably a wireless network), such as the Internet or local or wide area networks. For example, the electronic device 102 may allow a gift recipient to communicate using e-mail, text messaging, instant messaging, or other forms of electronic communication. In accordance with such embodiments of the invention, the electronic device 102 may also communicate with other devices using short-range wireless connections, such as Bluetooth®, radio-frequency identification (RFID) and/or near field communication (NFC).

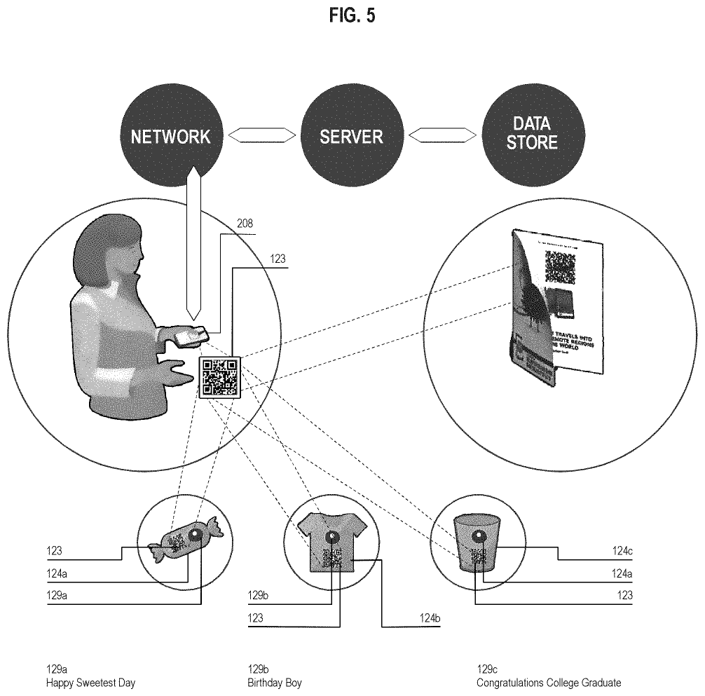

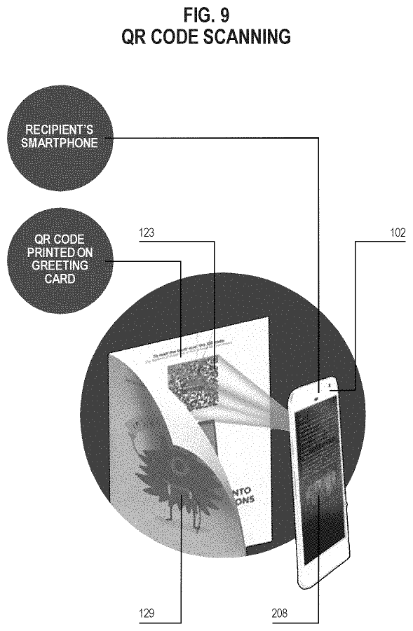

As illustrated in FIG. 9, the electronic device 102 uses a camera to create a QR code image of a QR code 123 attached to social expression social expression item 124. The QR code image is then analyzed by the processor 204 of the electronic device 102. For example, the electronic device 102 obtains a digital gift retrieval code 127 from the QR code 123 placed on the social expression item 124 (preferably a greeting card), and uses the obtained digital retrieval code 127 to retrieve from the network 116 the digital gift 125 associated with the social expression item 124. The social expression item 124 is preferably a social expression card or social expression product selected by the gift giver 109 and gifted to the social expression item/digital gift recipient 110. For example, (see also FIG. 5) the social expression item 124 may be a greeting card 124a, apparel, such as shirts 124b, hats, ties, jerseys, sweatshirts, sweat pants, etc. Also for example, the social expression item 124 may include party supplies such as, playing cards, paper plates, paper cups 124c, ceramic cups, ceramic plates, streamers, signage, etc. The social expression item 124 may also be edible products such as candy 124d with the social expression message 129 printed on individual candy wrappers or in the case of boxed candy on the box and/or candy liners. The social expression item 124 all include at least one printed social expression message 129 on the item which is selected by the social expression item giver 109. The social expression message 129 will typically include birthday wishes, congratulations regarding life events (graduation, promotions, new jobs, christenings, etc.), holiday greetings, romantic messages (wedding anniversaries, sweetest day cards, Valentine's day cards, Valentine's day candies, etc.), sympathy cards, get well cards, birth announcements, etc.

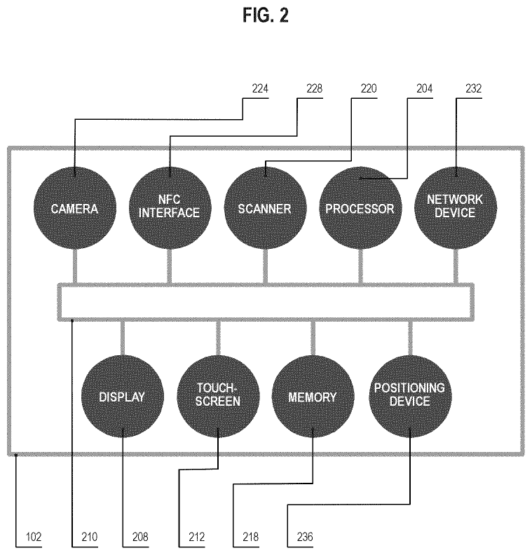

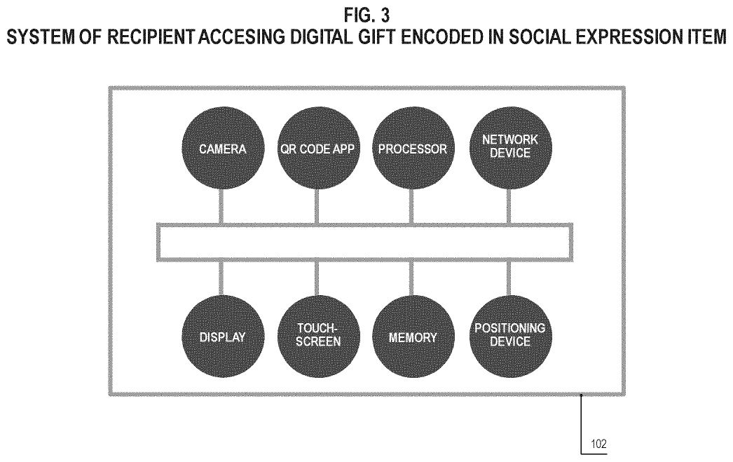

FIG. 2 illustrates a block diagram of an example electronic device 102 in accordance with various embodiments. As illustrated, the device 102 is enclosed by an external casing 202 that protects the interior components from being damaged. The external casing can be made of any suitable material such as plastic, metal, etc. The electronic device 102 may include any number of tactile input controls, including switches, keys, buttons, touch sensitive buttons, etc. The device 102 also includes a display 208 which may display various images generated by the device. The display 208 may be any type of display such as a light-emitting diode (LED) based display, a Retina display, a liquid-crystal display (LCD), etc. The device 102 preferably includes a touch screen 212 that a gift recipient 110 can select elements of the display 208 by touching the selected elements.

The display 208 may be used to display a graphical user interface (GUI) that allows a social expression item/digital gift recipient 110 to interact with the device 102. The tactile input controls or the touchscreen may be used to navigate the GUI. For example, the icons may be selected by touching the appropriate location of the touch screen 212. When an icon is selected, the device 102 may be configured to open an application associated with that icon and display a corresponding screen. For example, when a digital gift book icon 233 is selected, the device 102 may open a digital gift book file 233 in accordance with the invention and display the content of the digital book data file 235 to the digital gift recipient 110. The electronic device 102 also preferably includes audio input and output elements, such as microphones that receive audio input, speakers that output sound, headphones jacks for use with wired earbuds or headsets.

The electronic device 102 may include one or more processors 204 that provide the processing capability required to execute the operating system, applications, and other functions of the device 102. The one or more processors 204 may include general and special purpose microprocessors and/or a combination thereof. The processor 204 also may include on board memory for caching purposes and may be connected to a data bus 210 so that it can provide instructions to the other devices connected to the data bus 210.

The electronic device 102 also preferably includes storage memory 218 for storing data required for the operation of the processor 204 as well as other data required by the electronic device 102. For example, the storage memory 218 may store the firmware for the electronic device 102 usable by the one or more processors 204, such as an operating system, other programs that enable various functions of the electronic device 102, GUI functions, and/or processor functions. The storage memory 218 may also store data files such as software applications, and digital gift files whether audio, visual, video, etc.

The electronic device 102 may also include one or more networking components 232 for receiving and transmitting information over one or more communications channels. As such, the network components 232 may include one or more network interface cards (NIC) or a network controller. In some embodiments, the network components 232 may include a local area network (LAN) interface for connecting to a wired Ethernet-based network and/or a wireless LAN, such as an IEEE 802.11x wireless network (i.e., WiFi). In certain embodiments, the LAN interface may be used to receive information, such as the service set identifier (SSID), channel, and encryption key, used to connect to the LAN.

The networking component 232 also may include a wide area network (WAN) interface that permits connection to the Internet via a cellular communications network. The network component 232 may also include a personal area network (PAN) interface for connecting to a PAN such as a Bluetooth®network, an IEEE 802.15.4 (ZigBee) network, or an ultra wideband (UWB) network. The network device 232 may interact with an antenna to transmit and receive radio frequency signals of the network. The network device 232 may include any number and combination of network interfaces.

The electronic device 102 may also include a positioning device 236 used to determine geographical position. The positioning device 236 may utilize the global positioning system (GPS) or a regional or site-wide positioning system that uses cell tower positioning technology or WiFi technology, for example.

One of ordinary skill in the art will recognize various devices and techniques for implementing the scanner 220. The device 102 preferably is a smartphone which includes a camera 224. The camera 224 may be used as part of the overall system to extract the digital gift retrieval code 127 from the QR code 123 located on the social expression item 124. For example, the camera 224 may be used to capture an image of a QR-code 123 or similar printed optical data indicia, which then may be processed by the device 102 to extract the encoded digital gift retrieval code 127. Techniques for processing a video image to extract coded information such as a digital gift retrieval code 127 from a QR code 123 or similar printed optical indicia will also be known by those of ordinary skill in the art.

Alternately, the device 102 may include a scanner 220, such as a QR code scanner that may be used to obtain item identifying information from a printed QR code (or similar printed optical data indicia) associated with a social expression item 124, which then may be used by applications installed on the device 102.

The device 102 may further include a near field communication (NFC) interface 228 that allows for close-range communication, and may comply with such standards as ISO/IEC 18092, ISO/IEC 14443, ISO/IEC 21481, as well as others known by those of ordinary skill in the art. The NFC interface 228 may, for example, have a range of about 2 to 4 centimeters. The close-range communication with the NFC interface 228 may take place via magnetic field induction, allowing the NFC interface 228 to communicate with a device having an embedded digital gift retrieval code 127 that works with NFC. Alternate digital gift retrieval codes may include, for example, an encoded NFC tag or an encoded radio frequency identification (RFID) tag. In this way, the NFC interface 228 may be used to gather the digital gift retrieval code 127 associated with the social expression item 124.

Referring now to FIG. 5, an example QR code 123 is shown having been printed on, attached to, embedded in, or otherwise associated with several social expression items 124. According to embodiments, QR code 123 (or similar optically readable encoded indicia) are inexpensive to print on or otherwise integrate onto different social expression item items 124. The QR code 123 may be printed, silk screened or otherwise applied directly to the social expression item 124 whether paper, cloth, plastic, paperboard, etc. As illustrated, the QR code 123 which encodes the digital gift retrieval code 127 may also be woven into, sewed to, glued to, knitted to, stuck to, or otherwise attached to the appropriate location on a social expression item 124, such as chocolates 124a, t-shirts 124b, candies 124c, or drinking cups 124d. The QR code 123 may also be printed on social expression item 124 packaging such as shown on chocolates 124a and candies 124c. In most cases, the most efficient method will be to print the QR code on an adhesive sticker and adhere the sticker to the social expression item 124. Further, for example, with social expression t-shirts or apparel that is meant to be worn repeatedly (non-novelty apparel) the QR code 123 can be integrated into or attached to internal tags (similar to washing instruction tags) that are attached to the inner surface of social expression item garment 124 so the QR code 123 is not visible to the casual observer. It should be appreciated that these are merely examples and that smart QR codes or similar optical readable indicia can be attached or placed on or adhered to any type of social expression item 124 according to any manner know by those having skill in the art.

In some embodiments, the data transmitted from the storage memory 218 and digital gift retrieval code 127 include instructions that cause the electronic device 102 to perform a specific operation, such as launching a particular application or load a particular webpage. In other embodiments, the storage memory 218 and digital gift retrieval code store and transmit a digital gift identifier to the electronic device 102, and an application independently running on the electronic device 102 determines how to handle the digital gift identifier . In still other embodiments, the storage memory and digital gift retrieval code store 416 and transmit a website address, an email address, a physical address, and so forth.

Referring again to FIG. 1, the network 116 may include any appropriate network, including an intranet, the Internet, a cellular network, a wireless local area network, a local area network, a wide area network, a wireless data network, or any other such network or combination thereof. Components utilized for such a system may depend at least in part upon the type of network and/or environment selected. Protocols and components for communicating via such a network are well known and will not be discussed herein in detail. Communication over the network may be enabled by wired or wireless connections and combinations thereof.

The illustrated environment 100 includes at least one server 122 and a data store 130 dedicated to the digital gift retrieval portion of the systems and methods of the invention. The computer system and processes for creating and distributing the social expression items 124 containing the digital gift retrieval codes 127 are discussed separately below. It should be understood that there may be several servers (e.g., application servers, web servers, etc.), layers, or other elements, processes, or components, that may be chained or otherwise configured, and that may interact to perform tasks, such as obtaining data from an appropriate data store. As used herein the term “data store” refers to any device or combination of devices capable of storing, accessing, and/or retrieving data, which may include any combination and number of data servers, databases, data storage devices, and data storage media, in any standard, distributed, or clustered environment.

According to one embodiment, the server 122 is an application server that includes any appropriate hardware and software for integrating with the data store 130 as needed to execute aspects of one or more applications for the client device 102, and may even handle a majority of the data access and business logic for an application. For example, the server 122 can be an application server that provides access control services in cooperation with the data store 130, and that is able to generate digital gift content such as text, graphics, audio, and/or video to be transferred to the gift recipient, which may be served to the gift recipient by a native application on the client device 102 by a web server in the form of HTML, XML, or another appropriate structured language.

The data store 130 is operable, through logic associated therewith, to receive instructions from the server 122, and obtain, update, or otherwise process data in response thereto. In one example, a social expression item/digital gift recipient 110 might submit a request for the digital gift 125 related to a particular social expression item 124. In this case, the data store 130 might access stored gift recipient 110 information to verify the identity of the gift recipient 110, and it may access stored information to obtain information about the social expression item 124. Identity verification is an optional feature which the digital gift giver may select when creating the social expression item 124 so that any uploaded or created audio, radio or text digital gifts does not get delivered to inappropriate recipients. In this way, the privacy of the gift giver 109 is maintained so that more intimate and personal digital gifts do not fall into the hands of minors, strangers, or become republished. An identity verification code can be embedded within the QR code 123 or can be separately transmitted by the gift giver 109, or gift recipient 110 via e-mail, or other messaging means. The information then may be displayed to the gift recipient 110. The gift recipient 110 may review the results via a native application on the gift recipient's device 102 or via a webpage that the gift recipient 110 is able to view via a browser on the gift recipient device 102.

According to embodiments, any time a mobile browser on an electronic device 102, such as a mobile device, makes a request for, the browser can evaluate information provided by the native device. For example, mobile browsers and other applications (such as applications described herein for communicating with the digital gift content manager) are capable of providing programming interfaces into the native mobile device. In accordance with certain embodiments, information stored locally on electronic devices such as browser cookies and cache, is used to select the correct digital gift to be provided to gift recipients 110. For example, the information stored locally on a gift recipient's electronic device 102 may reflect the gift recipients tap behavior. This information can be interrogated by the web browser, and the result of the interrogation is fetching predetermine web address URLs and/or rendering predetermined HTML code. For instance, when a gift recipient taps on an item with their electronic device and the device provides no local information (e.g., this could be a first tap), then electronic device's browser fetches a default mobile website. This website will be stored on the electronic device to be used for future taps.

Next the gift recipient taps and icon for a digital gift item 124, the stored website is rendered as a splash page to present something locally to mobile browser and the gift recipient while data is fetched from the network. This will give immediate feedback to the consumer upon taping an icon for a digital gift item 124 and thus improve the customer's experience. Additionally, treasure hunts and other campaigns could be implemented using local data to store on the electronic device 102 each location achieved. Thus, in the case of areas with poor network connectivity, the gift recipient 110 would be able to check-in to locations because the information would be stored locally on the native device. In some cases, when the network connectivity is restored, the check-in data can later be sent to a remote server.

The server 122 may include an operating system that provides executable program instructions for the general administration and operation of the server, and it may further include computer-readable medium storing instructions that, when executed by a processor of the server, allow the server to perform its intended functions. Suitable implementations for the operating system and general functionality of the servers are known or commercially available, and are readily implemented by persons having ordinary skill in the art, particularly in light of the disclosure herein.

The environment 100 in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in the figures. Thus, the depiction of the environment 100 in FIG. 1 and other figures should be taken as being illustrative in nature, and not limiting to the scope of the disclosure.

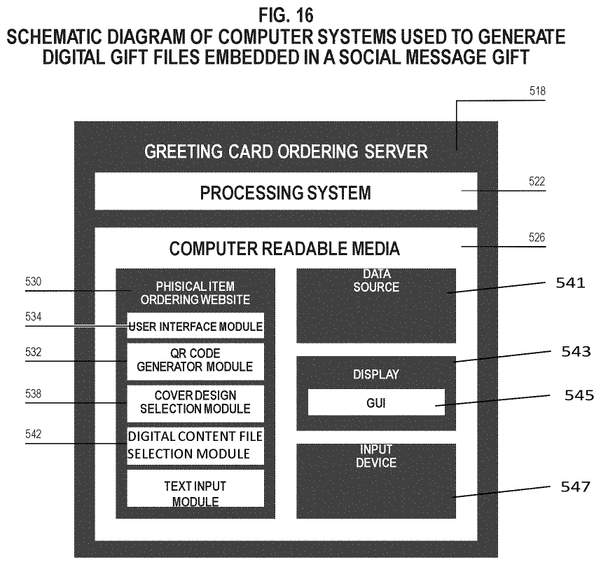

The environment of FIG. 1 may include additional components and/or other arrangements, as illustrated in system 518 of FIG. 16. In this example, the system 518 includes a digital gift file manager that responds to requests from electronic devices 102 to provide the electronic network device 102 with digital gift 125 related to particular social expression items 124. In some embodiments, the digital gift file manager is an application executed on the server 122. The digital gift file manager can be launched, viewed, and/or controlled using an electronic device 102, such as via a web browser window.

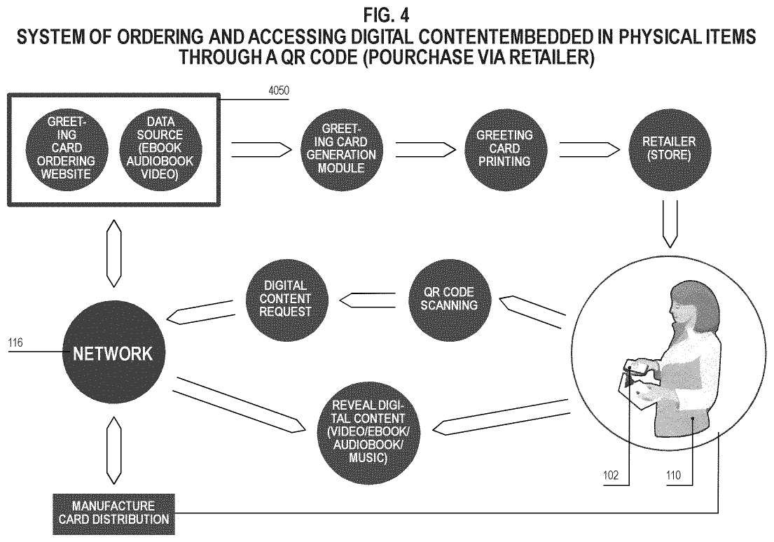

As best seen in FIGS. 1, 4, and 9, the social expression item/digital gift recipient 110, for example, uses the electronic device 102 to scan the QR code 123 of the social expression item 124 and send a request to the digital gift file manager to provide the electronic device 102 with the digital gift file 125 that is encoded by digital gift retrieval code 127 which is encoded onto into QR code indicia 123. According to the illustrated embodiment, the digital gift file manager may include an application download module, in-store data module greeting card ordering system 519, processing system 522, a computer readable media 526, a physical item ordering website 530, a gift recipient interface module 534, a QR code generator module 532, a cover design selection module 538, and a digital file selection module 542. The system may include a text input module, a data source, a display 543, GUI 545, and input device 547. The digital gift file manager reads and/or writes data to an application data store, a digital gift information data store, a social expression item giver information data store, a retailer data store, a digital gift data store, and digital gift recipient data store. The data stores may be implemented as part of the digital gift file manager or separately from the digital gift file manager depending on the embodiment of the invention.

Application information may include, for example, applications that are available for download to an electronic device 102 of a gift recipient 110 and that will enable the gift recipient 110 to interact with the digital gift file manager. For example, the application information may include applications that interact with the in-store data module to provide gift recipients 110 with information or offers related to the social expression items received that are associated with digital gift file(s) 125 stored on the gift recipient's device 102. Also for example, the application information may include applications that interact with the gift recipient's device 102 to send purchase suggestions related to the social expression items 124 and digital gift(s) 125 received by gift recipients' electronic devices 102 while the gift recipients are shopping in brick-and-mortar stores. These purchase suggestion selections can be related to the data stored on the recipient's device 102 concerning all the received social expression items 124 and digital gift items 125 and/or may include purchase selections related to or correlated with social expression items 124 and/or digital gifts 125 that the recipient has himself sent to others which data is stored on recipient's device 102. It should be appreciated that these are just illustrative examples of applications that may be stored in the application information data store, and that other applications may be provided. Such applications may interact with the digital gift recipient data store, the modules 530, gift recipient interface module 534, the module 538, the digital file selection module 542, among others. It should be appreciated that one or more applications can be provided for interacting with some or all of the modules discussed above.

Item information may include, for example, a table of social expression item identifiers and corresponding item descriptions, prices, model numbers/names, sizes, colors, as well as links/references to the digital gifts 125 associated with each social expression item 124 that is available in the digital gift data store, identifiers of digital gift givers 109 and digital gift recipients 110, and links/references to gift recipient accounts stored in the gift recipient information. Item information may also include information about the cost, design, manufacture, and selling price and distribution of the social expression items 124 and associated digital gift items 125. Item information may also include the names, prices, and other information concerning ancillary or compatible social expression items 124, digital gifts 125, and other products that other similarly situated gift givers 109 and/or gift recipients 110 have purchased.

Social expression item/digital gift giver 109 information may include, for example, (1) personal information about the gift giver 109, such as age, gender, income, current location information (e.g., city, region, address), phone numbers, email addresses, interests, social network memberships, and the like; (2) gift giver purchase history identifying social expression items 124 previously purchased by the gift giver 109, the price paid for items 124, and the merchant(s) from whom the items were purchased; (3) a history of social expression item/digital gifts given by the gift giver 109, including the identities of the gift recipients 110 to whom the social expression items 124 and digital gifts 125 were sent, and (4) the history of any social expression items 124 and associated digital gifts 125 that have been received by the gift giver 109 including the identity of the purchaser of those received social expression items 124 and digital gifts 125. The identities of any social expression items 124 or associated digital gifts 125 recommended on social media 124, the dates of such social media recommendations, and whether the recommendations were converted into actual purchases by others with connections or links to the gift giver's social medial accounts. In some examples, the social expression item recommendations may be made by other digital gift givers/recipient via social networks and/or media, blog comments and entries, and other electronic communications. Also for example, it is preferred that the gift giver 109 can merely “tap” an icon representing social expression item 124 using their electronic device 102, thereby causing an application on the electronic device 102 to recommend the social expression item 124 on the gift givers social media accounts of the gift giver.

Social expression 124/digital gift recipient 110 information 565 may include, for example, (1) personal information about the gift recipient, such as age, gender, income, current location information (e.g., city, region, address, phone numbers, email addresses, interests, social network memberships, and the like; (2) gift recipient purchase history identifying items 124 previously purchased by the gift recipient, the price paid for social expression items 124, and the merchants from whom the social expression items were purchased; (3) a history of recommendations made by the gift recipient, including the identities of the people to whom the recommendations were made, the recommended social expression items 124, the dates of the recommendations, and whether the recommendations were converted into actual purchases; and (4) the history of any social expression items 124 and associated digital gifts 125 that have been previously sent by the digital gift recipient 110 including the identity of any recipient(s). In one example, the recommendations can be made by the gift recipient 110 via social networks and/or media, blog comments and entries, and other electronic communications. Also for example, the gift recipient 110 can “tap” an icon graphically representing the social expression item 124 on their electronic device 102, thereby causing an application on the electronic device 102 to recommend the social expression item 124. The gift recipient identifier can be used to provide security codes to ensure that any gift giver generated digital gift file (i.e., audio or video files) remain confidential and are restricted to either only persons expressly selected by the gift giver 109. Alternately, the gift giver 109 may opt to allow the gift recipient 110 to forward gift giver generated gift file to one or more third parties, or to publish that gift file without restriction.

Digital gift recipient information may also include, as an additional example, (5) data storage and retrieval instructions for the digital gifts 125 delivered to the gift recipient 110. In this embodiment of the invention, the gift receiver 110 can choose to permanently store the digital gift item 125 for later retrieval on the storage media associated with the web portal. This can cause the gift recipient 110 to make repeated visits back to the web portal creating additional opportunities for the sale of additional social expression items 124 as well as an ancillary products and services offered on the web portal.

Both social expression item giver 109 and digital gift recipient 110 information may be obtained through various mechanisms. Gift givers 109 and/or recipients 110 may expressly input and provide the relevant information through a website application. For example, a website or application may enable a gift giver 109 and/or gift recipient 110 to create and manage a profile or account that is incorporated into the gift giver/gift recipient information data stores, respectively. The gift giver/gift recipient information may be obtained from a database of recorded historical purchases (online and/o offline), the gift giver's/recipient's Internet search history, gift giver/recipient demographic information, social graph (e.g., network of friends, relatives, work associates, etc.), and the like.

Gift giver/gift recipient information may indicate which social expression items 124 have been given/received to which gift recipients. For example, the gift giver/gift recipient information may include a table of social expression item identifiers, digital gift identifiers, and corresponding gift recipient identifiers as well as giver of each social expression item 124 and digital gift 125. It should be appreciated that the gift giver information may be included with the item information and/or the gift recipient information.

Digital gift 125 may include, for example, text, images, video, games, and links to websites, any of which could include information related to the social expression items 124. According to some embodiments, an entity associated with a social expression item 124 (e.g., manufacturer, merchant, retailer, vendor, advertiser, etc.) may provide, as part of the digital gift 125, information about other social expression items, brand imagery, logos, advertising, or promotional material related to the digital gift 124 and/or social expression item 125. For example, an entity may provide information about related products, top-selling social expression items, newest social expression items, social expression items within a certain price range, social expression items/digital gifts popular in specific geographic locations and markets, and information about any other products that might complement the already purchased social items 124 or digital gifts 125. For example, if a gift recipient is interested in a particular singer, artist, or writer, the entity may provide examples of other social expression items digital gift(s) 125 that complement the music, art, or writings of the singer, artist or writer, and the like.

In one embodiment of the invention, the social expression item giver 109 can generate custom audio, video, or image files that serve as the digital gift 125 that are either temporarily or permanently stored on the web portal. Examples of typical gift giver 109 generated audio or video files are as follows: audio recordings of birthday greetings, audio/video recordings of newborn babies for birth announcements, video recordings of early childhood birthday celebrations or birthday parties, digital image files of celebrations, wedding receptions, etc., video or audio recordings of parties of family member music, dance or other performing art recitals or performances.

Gift retrieval/use information may include, for example, the locations where it was determined that a gift recipient 110 used a digital gift 125 and corresponding information, such time and exact location of use. For example, the location of retrieval/use could be GPS location, address, city, state, region, and/or country. The location of use could also be the name or other identifying information of the business entity where the social expression item 124 was purchased, such as a gift shop, mass market retailer, or through on-line ordering. The retrieval/use information may include a table of item identifiers and corresponding time, location, and/or gift recipient data for the instances where each digital gift has been retrieved/used, that is, viewed, read, listened to, etc. It should be appreciated that the retrieval/use information may be included in the item information and/or the gift recipient information.

Bonus gift information may include, for example, information about additional benefits/services purchased by the gift giver 109 for the digital gift recipient 110. For example, additional benefits/services may be delivered directly to the electronic devices 102 via text messages, email, or push message. Information enabling additional digital benefits/services may include enhanced access to a musician, artist, writer or performer upon entering a concert, public author reading/book signing, art gallery event, or access to an express line or separate entrance at a public event. Benefits may also include access to exclusive premium artist/performer/writer services not otherwise available to the public, such as, tickets to advanced screenings, access to artist hosted events, private book signings, etc.

According to another embodiment, the application download module downloads applications from the application information to the electronic device 102 that enable the social expression item 109/digital gift recipient 110 to use the electronic device 102 to interact with the digital gift file manager. For example, the application download module may download from the application information an in-store shopping application that provides information about on-sale social expression items 124 (with associated digital gifts 125) and enables gift recipients 110 to obtain and view information about such social expression items 124 and digital gifts 125. Other example applications are discussed herein.

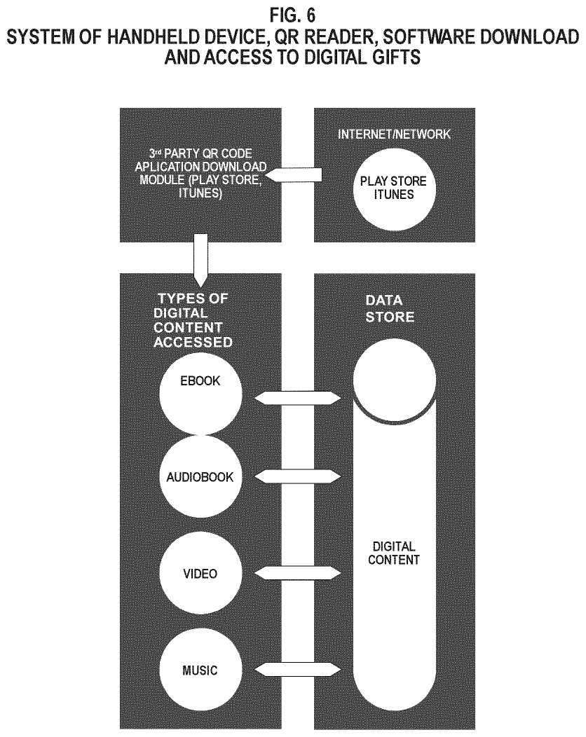

FIG. 6 is a block diagram depicting the system of acquisition of QR code reader, digital gift storage, including software download and access to digital gifts. A process determines which application to use to request and display digital gift 125 and, if the application is not already installed, download and install the application to an electronic device 102, according to an embodiment. The process (or any other processes described herein, or variations and/or combinations thereof) may be performed under the control of one or more computer systems configured with executable instructions and may be implemented as code (e.g., executable instructions, one or more computer programs, or one or more applications) executing collectively on one or more processors, by hardware, or combinations thereof. The code may be stored on a computer-readable storage medium, for example, in the form of a computer program comprising a plurality of instructions executable by one or more processors. The computer-readable storage medium may be non-transitory. The one or more computer systems may be, as an example, one or more computer systems in the environment 100 of FIG. 1 that collectively implement the digital gift file manager described above in connection with FIG. 5.

The process generally begins when someone, typically the social expression item/digital gift recipient 110, scans a QR code 123 associated with a social expression item 124, typically for sale in a store where the social expression item/digital gift recipient 110 is shopping. The electronic device 102 processes data received from the QR code 123.

In some embodiments, the data from the QR code 123, when processed by the electronic device 102, causes the electronic device 102 to execute an application that displays digital gift 125 related to the social expression item 124. For example, processing the data received from the QR code 123 causes the electronic device 102 to execute a web browser that loads from a web server a webpage specified in the data from the QR code 123. In this example, the data from the QR code 123 directs the electronic device's web browser to a particular webpage, which provides digital gift 125 related to the social expression item 124. In some examples, the web browser is a standard web browser that comes preinstalled on many electronic devices. In operation, according to an illustrative example, the social expression item/digital gift recipient 110 uses the electronic device 102 to “photograph” or “scan” the QR code 123 of a social expression item 124, such as a shoe. The saved instructions on the QR code 123 cause the electronic device 102 to open a web browser and go to a website with information about the social expression item 124 (price, name, images, text, videos, etc.). In some cases, a cookie saved on the electronic device 102, such as in the web browser, causes the web browser to open a particular webpage, which displays a specific digital gift 125, every time a QR code 123 is scanned. According to some examples, the webpage or website displayed can be influenced by location of scan, time, day of the week, marketing campaign to be run, previous scan locations, other scans by friends.

It should be appreciated that applications, other than web browsers, can be launched, opened, and/or executed by the electronic device 102 upon scanning a QR code 123 to display digital gift 125 related to the social expression item 124. For example, a manufacturer or a retailer of a social expression item 124 can make available for download to the electronic device 102 an application that enables the social expression item/digital gift recipient 110 to view digital gift 125 associated with scanned social expression items 124. Example screen shots of such applications are provided.

In other embodiments, the data from the QR code 123, when processed by the electronic device 102, causes the electronic device 102 to execute an application that can be used with the social expression item 124 to enhance the gift recipient's experience with the social expression item 124. For example, if the social expression item 124 is a smiley, then the application can track the gift recipient's use of the digital gift 125 and recommends other digital products related to digital gifts, e.g., books by related authors, books within a specific genre, music by a certain author, music with a given genre.

If the application specified by the data of the QR code 123 is already installed on the electronic device 102, the process proceeds to where the electronic device 102 launches, opens, switches to, or otherwise executes the application (e.g., the application could be a web browser that is already open on the device, and the data from the QR code 123 causes the web browser to go to a particular webpage or website). However, if the application specified by the data from the QR code 123 is not already installed on the electronic device 102, the process proceeds to where the data from the QR code 123 causes the electronic device 102 to send a download request to the application download module of the digital gift file manager. The download request includes information obtained from the QR code 123 that identifies the appropriate application (e.g., the application could be provided by a retailer or manufacturer of items).

Responsive to the download request, the application download module of the digital gift file manager sends the electronic device 102 a link to download the application. The electronic device 102 asks the social expression item/digital gift recipient 110 to confirm whether the social expression item/digital gift recipient 110 desires to download the application. It should be appreciated that the application is automatically downloaded, without requesting approval from the gift recipient 110. The process ends if the gift recipient 110 does not confirm. However, if the gift recipient 110 confirms, the application is downloaded to the electronic device at block 640, and the electronic device 102 launches the application.

Referring again to FIG. 5, the in-store data module receives from the gift recipient device 102 of the social expression item/digital gift recipient 110 a request to provide digital gift 125 related to one or more items 124 being offered for sale, selects digital gift 125 to send to the social expression item/digital gift recipient 110, and sends the selected digital gift 125.

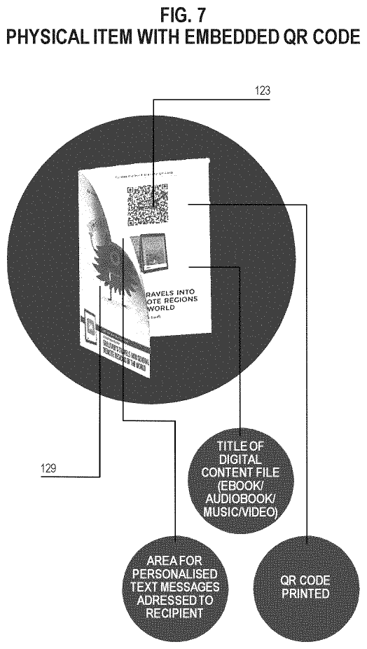

FIG. 7 is schematic diagram illustrating an example of a social expression item in accordance with at least one embodiment of the invention. Exemplary retail store where a gift recipient 110 may be shopping when the gift recipient queries the in-store data module for information about a social expression item 124 being offered for sale, in accordance with at least one embodiment. It should be appreciated that the retail store is described herein for purposes of illustrating operation of the in-store data module and other components of the digital gift file manager. As such, the description of the retail store is not intended to limit embodiments of the various inventions described herein.

Social expression items 124 represent various items of athletic apparel and equipment being offered for sale in the retail store, which is categorized into several sections, including a party supply section, a greeting card section, and an apparel section. Social expression items 124 related to party supplies are presented in the party supply section, social expression items 124 related to greeting cards are presented in the greeting card section, and so forth. By way of example, the social expression items 124 presented in the football section may include the greeting cards 124a, the t-shirts 124b, the paper cups 124c, and candy 124d. A QR code 123 is associated with each of the items 124 and stores, for example, an item identifier unique to each item. QR code readers capable of communicating with the digital gift file manager are provided at point-of-sale (POS) terminals and doorways. For example, the QR code readers provided at the doorways are embedded in or otherwise associated with floor mats that gift recipients 110 step on when entering and exiting the retail store. The QR code readers are capable of reading QR codes associated with gift recipient items, such as shoes, when gift recipients walk across the floor mat.

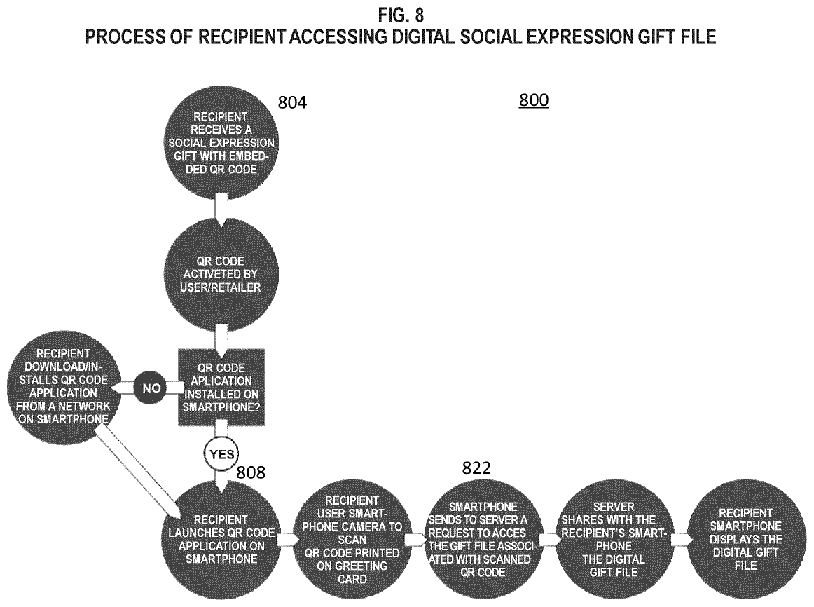

FIG. 8 provides a flow diagram illustrating an example process 800 of a constructing and sending a request to obtain digital gift 125 related to a social expression item 124. As indicated at 804, the process 800 generally begins when the gift recipient 110 causes the electronic device to “scan” the QR code 123 of the social expression item 124 for which the gift recipient 110 desires to view, listen to, or read the digital gift 125. For example, to scan the QR code 123, the social expression item/digital gift recipient 110 activates the QR code 123 of the electronic device 102, if the QR code 123 interface is not already active, and positions the code interface 228 proximate to the QR code 123 of the social expression item 124. During the scan, the electronic device 102 obtains from the QR code 123 the item identifier associated with the social expression item 124. The electronic device 102 may obtain additional information, such as instructions regarding which application to launch. It should be appreciated that the application could be a web browser, or an application designed specifically to scan the QR code 123 and obtain digital gift 125 related to the social expression item 124, or a general application for operating the code interface, etc. At 808, the electronic device 102 launches the appropriate application, or prompts the gift recipient 110 to download the appropriate application. As described above, the electronic device 102, upon receiving instruction code from the QR code 123, automatically launches the appropriate application or sends the appropriate download request to the application download module of the digital gift file manager.

Once the application is launched on the electronic device 102, the application displays a menu of options to the gift recipient 110. It should be appreciated that, as illustrated, upon the application launching at 808, the process 800 proceeds directly to 822, where a request is sent to automatically obtain digital gift 125 related to the social expression item 124, such as, video, audio files, music files, literary work files, images, etc. At 814, the gift recipient 110 selects from the menu the option to get digital gift 125 related to the social expression item 124.

FIG. 9 provides an example 904 of a menu of options, including a “get info” option 908. Responsive to the gift recipient's selection, the electronic device 102 constructs a request to provide digital gift 125 related to the social expression item 124. The request includes the item identifier that was obtained from the QR code 123 associated with the social expression item 124. It should also be appreciated that the implicit or explicit request can include a gift recipient identifier of the gift recipient 110. At 822, the electronic device 102 sends the request to the digital gift file manager.

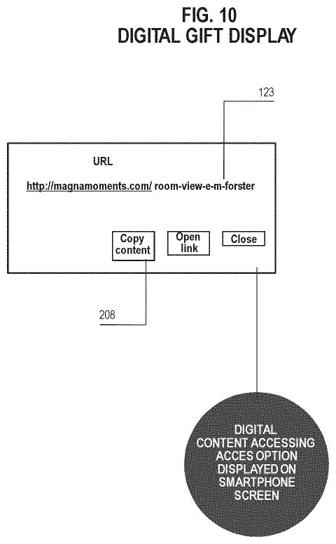

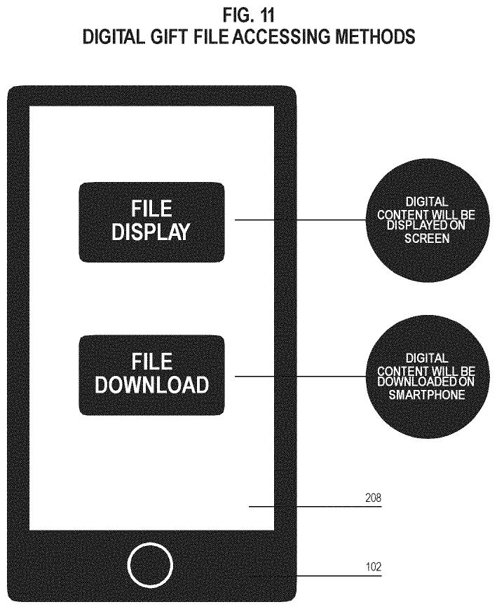

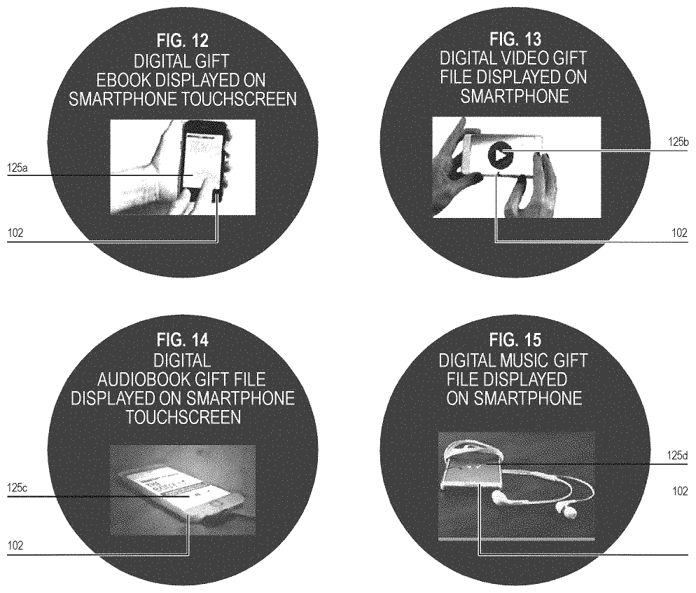

FIG. 10 is a schematic diagram of example screenshots of a menu giving a gift recipient an option to download or view the digital gift in accordance with at least one embodiment. The digital gift file manager, in response to the gift recipient's request, delivers digital gift 125 to the electronic device 102 of the gift recipient 110. The request to provide digital gift 125 is received. The request may be explicitly requested by the gift recipient 110, or it may be automatically requested, without an explicit request by the gift recipient 110. The in-store data module searches the item information and digital gift 125 data stores, to identify digital gift 125 related to the social expression item 124. To do so, for example, the in-store data module identifies all digital gift 125 associated with the item identifier included in the request. The in-store data module selects a subset of the identified digital gift 125 to provide to the gift recipient 110.

FIG. 11 is a schematic diagram of gift display and download options. The digital gift file manager selects a subset of the identified information to provide to the gift recipient 110. The process generally begins at 1104, where the geographic location of the gift recipient is determined. According to embodiments, the geographic location is provided in the request received from the electronic device. For example, the application that constructed the request obtained geo-location data from a GPS receiver of the electronic device and included the geo-location data in the request. In other examples, the request received from the electronic device 102 included (e.g. in the header of the request) the language, country, region, city, time zone setting of the electronic device 102, and the geo-location of the gift recipient 110 is inferred from that information. In still other examples the geo-location of the gift recipient 110 is determined based on cell tower and WiFi location data included in the request from the electronic device 102. The in-store data module determines which of the identified digital gift 125 is relevant to the geo-location of the gift recipient 110 by assessing the relevance of the identified digital gift 125 to the geo-location of the gift recipient 110. For example, the in-store data module assesses whether a language spoken in the geo-location of the gift recipient 110 matches the language in which the digital gift 125 is presented. Also for example, the in-store data module assesses the popularity in the geo-location of the subject matter of the identified digital gift 125, where the subject matter of the identified digital gift 125 can be a sport, a sporting event, a team, a venue, an article of apparel, type of apparel, a style of apparel, and a brand of apparel.

According to embodiments, the language of the social expression item 124/digital gift 125 presented to the social expression item/digital gift recipient 110 of the electronic device 102 matches the language setting of electronic device 102. Thus, regardless of which country the gift recipient 110 is located in when he ‘taps’ a social expression item 124, content is presented in the language that matches the language setting of the gift recipient's electronic device 102. For example, English-language information and digital gifts are presented to an English-speaking gift recipient whose electronic device's language setting is English, even if the English-speaking gift recipient ‘taps’ an item to request digital gift 125 while vacationing in Spain. Thus, the English gift recipient is presented with English-language information and or digital gifts, regardless where he is located when he uses his electronic device 102 to obtain digital gift 125 related to items 124. According to an embodiment, when the English-speaking gift recipient taps a social expression item 124 and his electronic device 102 sends to the server 122 a request for digital gift 125, the request includes the language setting of the electronic device 102. Responsive to the request, the server 122 selects the digital gift that is presented in a language that matches the language setting of the electronic device. It should be appreciated that data other than the language setting can be used, such as the home country setting, the home city setting, the web browser version, the device identifier, etc.

The location of the gift recipient 110 and/or the social expression item 124 within the store is determined. For example, the in-store data module determines whether the gift recipient 110 and/or social expression item 124 is located in the relevant section. According to some examples, the in-store data module has access to a store map, where the map details the locations of the items in the store based on item identifiers. For example, ranges of item identifiers are grouped into different locations of the store. Thus, using the map and the item identifier, the location of the gift recipient within the store can be determined. Additionally, the geo-location of the gift recipient can be cross-referenced against the map to determine the location of the gift recipient 110. As mentioned above, geo-location can be determined based on information obtained from the GPS receiver of the electronic device or from cell tower or WiFi location data. According to other examples, the location of the gift recipient within the store is determined based on a product category to which the social expression item 124 belongs. For example, if the social expression item 124 is a birthday card, then the gift giver 109 is determined to be in the greeting card section of the store. The in-store data module determines which of the related social expression items 124/digital gift 125 are relevant to the gift giver/gift recipient in the store by assessing the relevance of the identified social expression items 124 and associated digital gift 125 to the gift recipient110. For example, if the gift recipient 110 is having a birthday and the gift giver has selected a birthday related social expression item, then the in-store data module identifies which of the other social expression items 124 and associated digital gift 125 related to birthday celebrations.

Gift recipient information, such as gift recipient profile data, about the gift recipient is obtained from the gift recipient information data store. For example, the gift recipient information includes a home address of the gift recipient, a number of related purchases made by the gift recipient in the past, a number of related product recommendations the gift recipient has made, and the number of times those product recommendations converted into product purchase by the gift recipient or others. Any other useful gift recipient data may be obtained from the gift recipient information data base. The in-store data module determines which of the identified digital gift 125 is relevant to the gift recipient profile data. For example, the in-store data module identifies digital gift 125 that is related to: a popular musical group currently touring near the gift recipient's home location; the gift recipient's previous received digital gifts 125 and social expression items 124 and digital gift items given, social expression items 124 the gift recipient 110 has previously recommended; and/or social expression items 124 purchased by others at the recommendation of the gift recipient 110.

A web cookie and/or browser cache is obtained from the request received from the electronic device, which includes information about the gift recipient's online browsing history, depending on settings and approval by the gift recipient. The in-store data module identifies which of the identified social expression items 124 and associated digital gift 125 are related to the gift recipient's browsing history.

The digital gift 125 identified as being relevant to the social expression item 124 is evaluated against the information determined and/or obtained earlier to select the subset of social expression items 124 suggestions to send to the gift giver 109. As discussed above, digital gift 125 may include, for example, text, images, video files, and links to websites, any of which could include information about the social expression item 124 or the digital gift 125. According to embodiments, from the social expression items 124, the in-store data module identifies a subset of social expression items 124 that are relevant to the gift giver's geo-location and location within the store, the time of the request, the gift giver's stored data, and/or the gift giver's online browsing history, depending on settings and permission from the gift giver 109.

After selecting a subset of the identified digital gift 125, the in-store data module transmits or presents the subset to the electronic device of the gift recipient. The digital gift 125 includes a description of the item, suggested items that the gift recipient might be interested in, a link to view a video of how the item was made, and current news and events related to the item. A “next page” button may also be provided. The gift recipient can select the button to receive additional data files related to the social expression item 124 item. The digital gift 125 can also include the price of the item, a link to social network/media so that the gift recipient can see what his friends and others are saying about the item, and a link to a video about the backstory of the item. The digital gift 125 can also include a link to see how many of the items are in stock and the available color, sizes, annotations, etc. It should be appreciated that rather than providing a link, the actual inventory and available colors, sizes, and annotations can be provided directly to the gift recipient.

According to some embodiment, the gift recipient's “tapping activity” while shopping in a retail store can be shared with retail stores and other entities, subject to disclosure to the gift giver/gift recipient and permission from the gift giver/gift recipient. This data would benefit business by enabling tracking consumer behavior in store during shopping, looking at products and buying products. This would enable the business to target promotions to the gift giver/gift recipient based on the gift giver/gift recipient shopping habits.

An exemplary example process of security encoding for a digital gift 125 generally begins when the security encoding module receives a notice that the digital gift 125 has been purchased or otherwise acquired by a gift giver/gift recipient. The notice is transmitted via a purchase-indication message, which includes an item identifier for the social expression item 124 and digital gift 125.

In another embodiment of this third example, the gift giver can give a code/PIN to the gift recipient, who can submit the code/PIN for the security encoded digital gift 125 in order to get access to premium level services/benefits. For example, after purchasing a social expression item 124, the gift recipient can give the social expression item 124 to another gift recipient without prior registration of the item. This way, the purchased item is registered to the new owner and not to the purchaser. In some examples, the person who buys the product gets a PIN/code either on the receipt, on his mobile device or via email. This PIN/code is provided to the new owner, who can use the PIN/code to retrieve the premium services/benefits associated with the premium digit gift 125.

The gift recipient sends to the registration module his or her registration information. The registration information includes the gift recipient's gift recipient identifier. The server uses the gift recipient identifier to look up gift recipient's account in the gift recipient information. The item is registered to the gift recipient by including the item identifier or a reference to the item identifier in the gift recipient's account.

According to embodiments, upon launching, the application sends the item identifier to the digital gift file manager. The registration module uses the item identifier to look up ownership/security information for the social expression item and digital gift 125. When doing so, the ownership/security module will prevent unauthorized access to premium level services or gifts as well as restrict access to gift giver created digital gifts to those inputting the proper security codes.

According to embodiments, a gift recipient can scan QR code 123 with his phone on a social expression item 124 to obtain digital gift 125 related to the social expression item 124. Premium level owners (premium gift recipients 109) receive digital gift 125 purchased by the gift giver 110 for the premium level owner (premium gift recipient). These are exclusive, premium level data files that provides an engaging digital experience and may also provide access to a suite of preselected premium level services. As discussed above, premium level services/benefits enhanced access to musicians, artists, writers, or performers upon entering a concert, public reading/book signing, art gallery event that are related to the digital gift.

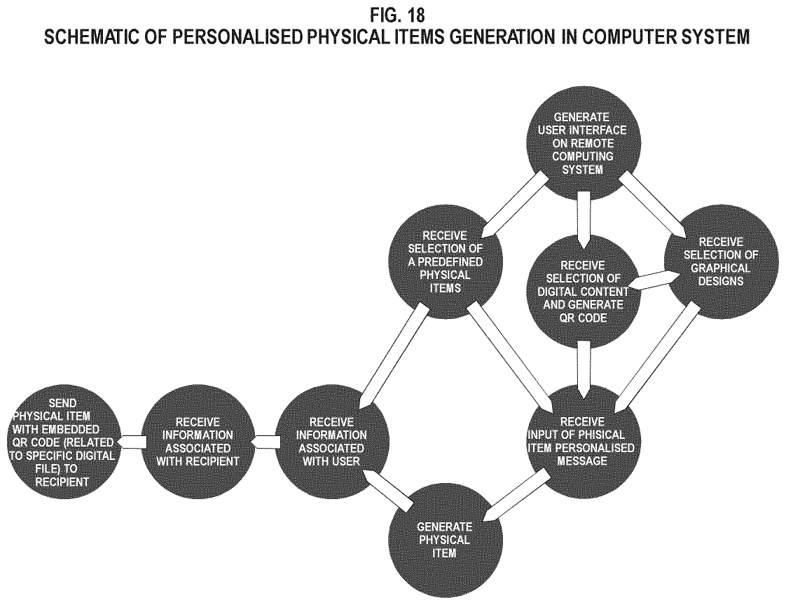

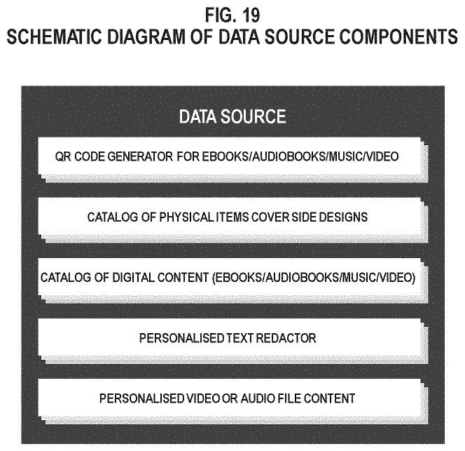

Turning to FIG. 18, example process 1800 generally begins at 1804, where the digital gift recipient 110 causes the electronic device to “scan” the QR code 123 of the social expression item 124 for which the gift recipient 110 desires to obtain digital gift 125. For example, to scan the QR code 123, the social expression item/digital gift recipient 110 activates the camera 224 of the electronic device 102 and positions the camera 224 proximate to the QR code 123 of the social expression item 124 to capture a digital image of the QR code 123. The electronic device then scans the QR code image, the electronic device 102 obtains from the image of the QR code 123 the item identifier associated with the social expression item 124. The electronic device 102 may obtain additional information from the image of the QR code 123, such as instructions regarding which application to launch, open, switch to, or otherwise activate. At 1808, the electronic device activates the appropriate application. For example, the instructions received from the QR code 123 may instruct the electronic device 102 to activate a specific application, such as a music playback application. Also, for example, the electronic device may know, based on the item identifier, the category of the digital gift 125 (e.g., music, video, literature) and therefore automatically activate the appropriate application (e.g., music playback, video player, e-reader). In yet another example, the electronic device 102 may launch an application that has several modes. In this example, if the digital gift 125 is a video file, then the application may start in a “video mode” so that the gift recipient 110 can simply start viewing after tapping the digital gift icon. Also in this example, if the item identifier of the digital gift indicates that the digital gift 125 is in the category of music, then the application of the digital device starts in “audio playback mode.” If the appropriate application is not already installed on the electronic device 102, the appropriate application is downloaded to the electronic device 102, and then launched. Upon launching, the application composes and sends to the digital gift file manager a request for digital gift 125 related to the social expression item 124. The request includes the item identifier obtained from the QR code 123 as well as a gift recipient identifier of the gift recipient 110. For example, the gift recipient identifier may be a gift recipient name, a number, a token, a serial number, a government-issued identification number, an International Mobile Station Equipment Identity (IMEI) number of the gift recipient's electronic device 102, or a security code associated with the gift recipient's information in the gift recipient information data store.

The digital gift includes either (a) relatively expensive “premium level files or services” or (b) gift giver created digital gift that has been designated as for limited or secure publication a security code is preferably required and the digital gift file manager receives the request from the electronic device 102. The digital gift file manager determines if the requesting gift recipient has provided the appropriate security code.

The digital gift file manager engages the security module to obtain from the gift recipient's request a social expression item identifier, digital gift identifier, and a gift recipient identifier. The security module uses the item identifier to look up security information for the digital gift 125. For example, the security module may locate a security record (a.k.a. subset of ownership or publication limitation data) for the digital gift 125 item. It should be appreciated that the security record can be located in any or all of the item information, the gift recipient information, or the digital gift information. The security module determines whether the gift recipient identifier is listed as a bona fide owner or permitted recipient of the digital gift 125. For example, the security module looks to see if the gift recipient's identifier is listed in the security record as a bona fide owner of the “premium files or premium services” or as a permitted recipient of gift giver created, limited publication digital gift. In these cases, the gift recipient identifier or a reference or link to the gift recipient identifier may be included in the owner column or permitted recipient column of the security record.

If the gift recipient identifier of the requesting gift recipient is listed or otherwise indicated as being a bona fide owner or permitted recipient of the social expression item 124/digital gift 125, then a conclusion is made that the requesting gift recipient 110 is a bona fide owner/permitted recipient of the digital gift 125. However, if the gift recipient identifier of the requesting gift recipient is not listed or otherwise indicated as being a bona fide owner or permitted recipient of the security protected digital gift 125, then a conclusion is made that the requesting gift recipient 110 is not authorized to receive the security protected digital gift 125.

According to one optional embodiment of the invention, in the event the requesting gift recipient is not listed as a bona fide owner or permitted recipient of the security protected digital gift 125, a determination is made regarding whether the gift recipient is associated with a bona fide owner or permitted recipient, such as by a social network. For example, if the requesting gift recipient is “friends” with a bona fide owner or a permitted recipient on a social network or media, then the requesting gift recipient 110 may be treated the same as or similar to the bona fide owner and/or permitted recipient.

If the digital gift 125 is owned, the requesting gift recipient (i.e., if the requesting gift recipient is a bona fide owner or permitted recipient) or, optionally if the requesting gift recipient is “friends” with a bona fide owner or permitted recipient, a menu of options designated for bona fide owners and permitted recipients is presented to the gift recipient. According to an embodiment, to provide a menu of options designated for bona fide owners, the bona fide owner module accesses the digital gift 125 and searches through the available options to identify options that are tagged as being available for bona fide owners or permitted recipients of the digital gift 125. Also, for example, the bona fide owner module accesses the gift recipient information to identify the menu options designated in the gift recipient's gift recipient account. The gift recipient 110 may have manually selected these options or the options may have been automatically inputted into the gift recipient account upon input of the appropriate security code of the digital gift. Further, for example, the bona fide owner module accesses item information to identify options available to bona fide owners and permitted recipients of the digital gift 125. The security module then compiles a list of available menu options and transmits the list for display by the electronic device 102 of the gift recipient. For example, the security module transmits the list to the appropriate application operating on the electronic device 102, and the application displays the listed options to the gift recipient 110.

A user can be provided with a menu of options designated for bona fide owners or permitted recipients, such as a welcome message that provides the name of the social expression item 124 and/or digital gift 125. An options menu can be presented below the welcome message.

Bona fide owners have the the option of obtaining early or unique access to social expression items, digital gifts, not yet available online or at retail based on the gift recipient's profile information. For example, the gift recipient may be presented with not-yet-released digital files; e.g., sneak previews of upcoming films, advanced chapters of not yet released literary works, pre-release access to music/music videos, etc. that the gift recipient can learn about and optionally purchase using the gift recipient device 102. The purchased items can then be delivered to the gift recipient's home or to his device 102.

Bona fide owners/permitted recipients, or other gift recipients with the option of re-assigning the item to another gift recipient. For example, in the event the bona fide owner sells or gives the item to another gift recipient, the bona fide owner can select to reassign the item to the new gift recipient 110. In some embodiments, the gift recipient is prompted to input the name, gift recipient identifier, or some other indication of the gift recipient to whom the digital gift is to be re-assigned. Upon doing so, the digital gift 125 manager updates the ownership/permitted recipient information to reflect that the digital gift 125 is now assigned to the new digital gift recipient. Thus, the privileges of being a bona fide owner transfer to the new owner.

As mentioned above, the premium benefit/services may be delivered to the electronic device 102 of the gift recipient 110 and may be priority access at a location or event. For example, the premium digital services can be delivered directly to their mobile phones via text message, email or push message. Also, for example, at a concert or sporting event, a bona fide owner of premium digital gift services can use a separate entrance or fast lane at a concert, performance, artist meet and greet, or athletic meet and greet, etc. To get such access, the bona fide owner presents his or hers electronic device 102 which will have received a digitally readable event access code.

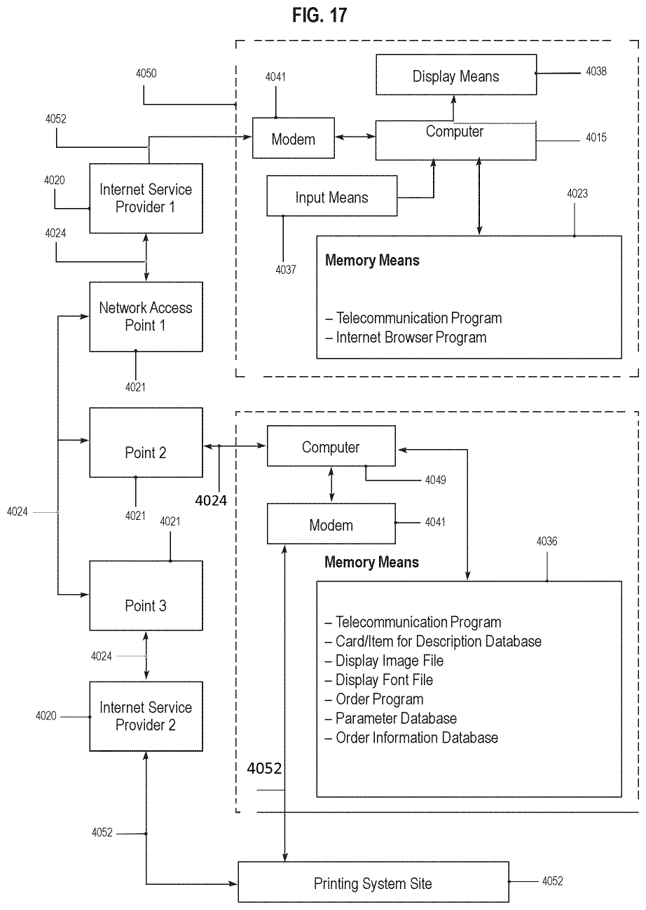

FIG. 17 is an example environment 2900 in which embodiments may be implemented. The environment 2900 includes a computer 2926, a network router 2912, a printer 2908, and a server 2910, interconnected by a network 2918, such as the Internet, wide area network, local area network, etc. The computer 2926 includes a monitor 2906, a processor 2902, and keyboard 2922. The computer 2926 can be, for example, a laptop computer, desktop computer, handheld computer, and electronic device, such as electronic device 102, a mainframe computer, etc. According to embodiments, gift recipients can input commands into the computer 2926 using various input devices, such as a touch screen, a mouse, the keyboard 2922, and track ball, etc.

The server 2910 may, for example, be used to store additional software programs and data. In one embodiment, software implementing the systems, methods, and processes described herein can be stored on a storage medium in the server 2910. Thus, the software can be run from the storage medium in the server 2910. In another embodiment, software implementing the systems, methods, and processes described herein can be stored on a storage medium in the computer 2926. Thus, the software can be run from the storage medium in the computer system 2926. Therefore, in this embodiment, the software can be used whether or not computer 2926 is connected to network router 2912. It should be appreciated that the printer 2908 may be connected directly to computer 2926, rather than via the router 2912.

The digital gift file manager and components thereof may be a special-purpose computer system. The above methods may be implemented by computer-program products that direct a computer system to perform the actions of the above-described processes and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general-purpose computer, it is transformed into the special-purpose computer system.

Special-purpose computer system comprises a computer having connected thereto gift recipient output device(s) (e.g., monitor), gift recipient input device(s) (e.g., keyboard, mouse, track ball, touch screen), communication interface, and/or a computer-program product stored in a tangible computer-readable memory. The computer-program product directs computer system to perform the above-described methods and processes. The computer may include one or more processors that communicate with a number of peripheral devices via a bus subsystem. These peripheral devices may include the gift recipient output device(s), the gift recipient input device(s), the communications interface, and a storage subsystem, such as random access memory (RAM) and non-volatile storage drive (e.g., disk drive, optical drive, solid state drive), which are forms of tangible computer-readable memory.

The computer-program product may be stored in the non-volatile storage drive or another computer-readable medium accessible to the computer and loaded into memory. Each processor may comprise a microprocessor, such as a microprocessor from Intel® or Advanced Micro Devices, Inc.®, or the like. To support computer-program product, the computer runs an operating system that handles the communications of product with the above-noted components, as well as the communications between the above-noted components in support of the computer-program product. Example operating systems include Windows® or the like from Microsoft Corporation, OS X® from Apple, Solaris® from Sun Microsystems, LINUX, UNIX, and the like.

Gift recipient input devices include all possible types of devices and mechanisms to input information to the computer. These may include a keyboard, a keypad, a mouse, a scanner, a digital drawing pad, a touch screen incorporated into the display, audio input devices such as voice recognition systems, microphones. The gift recipient input devices typically allow a gift recipient to select objects, icons, text and the like that appear on a monitor via a command such as a click of a button or the like. The gift recipient output devices include all possible types of devices and mechanisms to output information from computer. These may include a display, a monitor, printers, non-visual displays such as audio output devices, etc.

The communications interface provides an interface to other communication networks and devices and may serve as an interface to receive data from and transmit data to other systems, wide area networks (WANs) and/or the Internet. Embodiments of communications interface include an Ethernet card, a modem (telephone, satellite, cable, ISDN), a (asynchronous) digital subscriber line (DSL) unit, a FireWire® interface, a USB® interface, a wireless network adapter, and the like. For example, communications interface may be coupled to a computer network, to a FireWire® bus, or the like. In other embodiments, the communications interface may be physically integrated on a motherboard of the computer, and/or may be a software program, or the like.

The memory and non-volatile storage drive are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, barcodes, semiconductor memories such as flash memories, read-only-memories (ROMs), battery-backed volatile memories, networked storage devices, and the like. The memory and the non-volatile storage drive may be configured to store the basic programming and data constructs that provide the functionality of various embodiments of the present invention, as described above.

Software instruction sets that provide the functionality of the present invention may be stored in the memory and non-volatile storage drive. These instruction sets or code may be executed by the processor(s). The memory and the non-volatile storage drive may also provide a repository to store data and data structures used in accordance with the present invention. The memory and the non-volatile storage drive may include a number of memories including a main RAM to store of instructions and data during program execution and a ROM in which fixed instructions are stored. The memory and the non-volatile storage drive may include a file storage subsystem providing persistent (non-volatile) storage of program and/or data files. The memory and the non-volatile storage drive may also include removable storage systems, such as removable flash memory.

The bus subsystem provides a mechanism to allow the various components and subsystems of computer to communicate with each other as intended. Although bus subsystem is shown schematically as a single bus, alternative embodiments of the bus subsystem may utilize multiple busses or communication paths within the computer.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including ROM, RAM, magnetic RAM, core memory, magnetic disk storage mediums, optical storage mediums, flash memory devices and/or other machine-readable mediums for storing information. The term “machine-readable medium” includes, but is not limited to portable or fixed storage devices, optical storage devices, wireless channels, and/or various other storage mediums capable of storing that contain or carry instruction(s) and/or data.

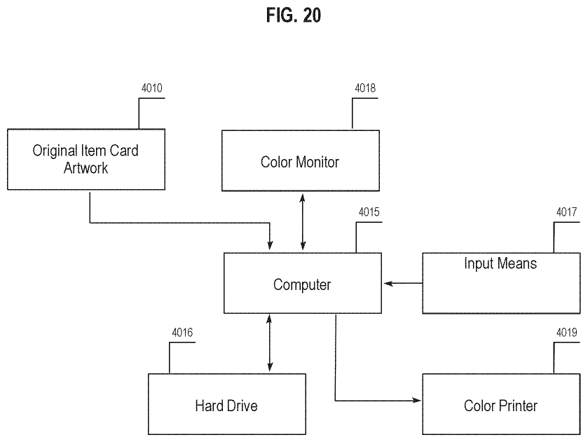

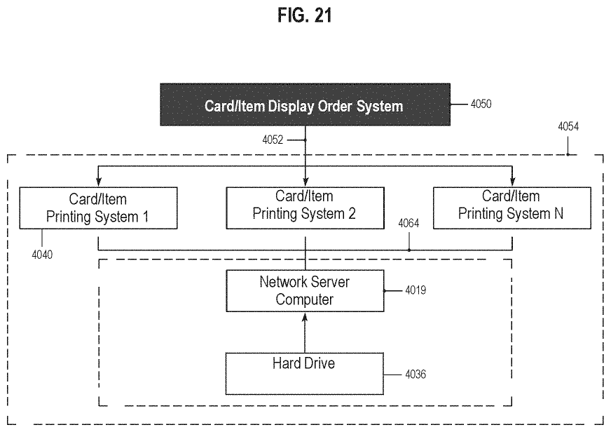

FIG. 20-21 show the relationship of the various system elements of the social expression item/digital gift ordering, delivery, portions of certain embodiments of the invention. Details of each system elements for purposes of convenience the term “card” has been utilized in this section, but is intended that the description includes social expression items generally.

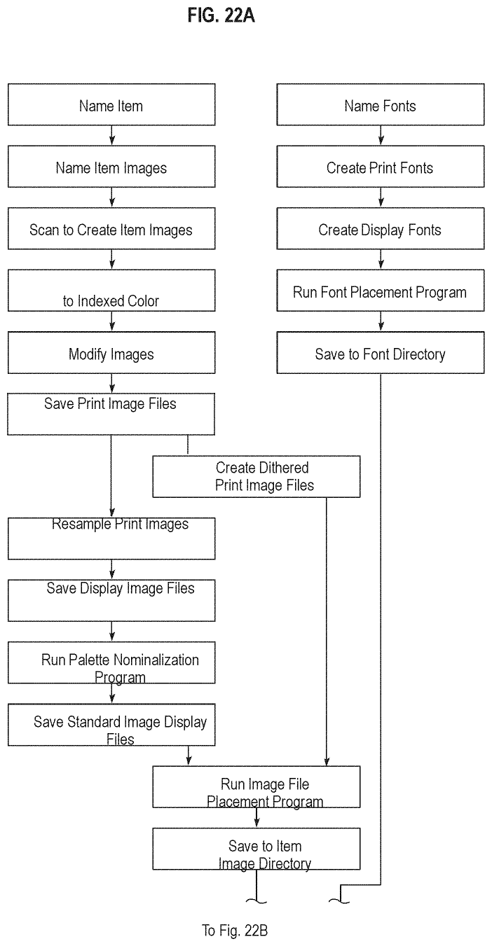

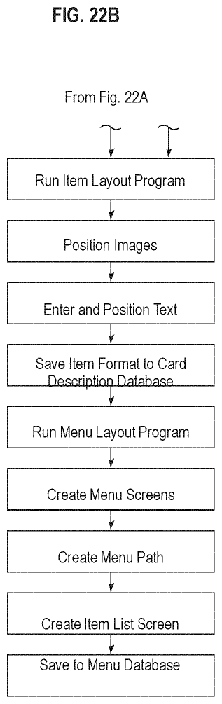

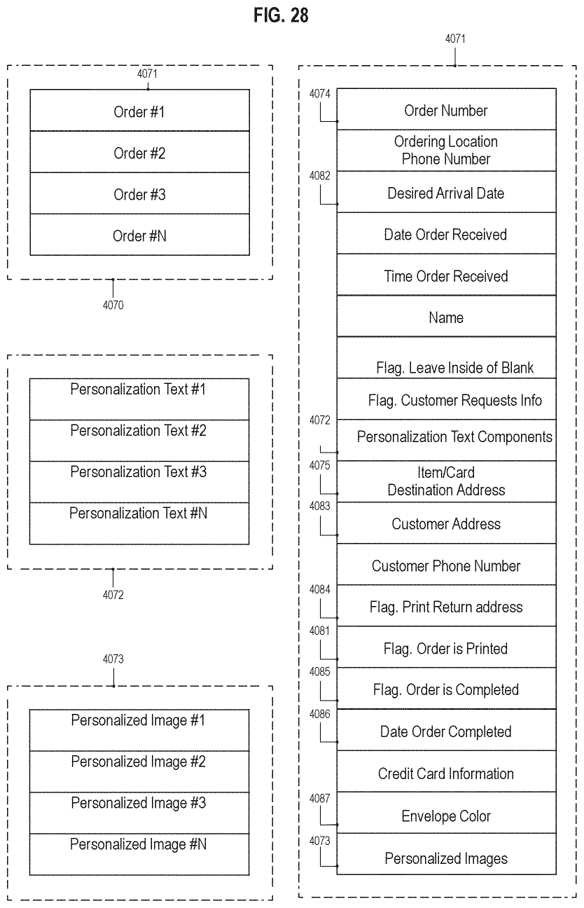

FIG. 21 shows an overall schematic view of the computer system 4050 used to prepare databases of social expression card/social expression item designs (“database preparation computer system”). The steps in this process are outlined in the flowchart provided in FIGS. 22A-22B. Copies of certain of these databases may then be transferred to a memory storage means which may be accessed directly by a single card/social expression item printing system 4040 or by one or more card printing systems, for example, through a network. The card/social expression item printing systems print cards/social expression items in response to card identification, personalization, and other order information received through one or more electronic data communication means. Alternatively, copies of these databases may be distributed electronically to a number of networked card/social expression item printing systems either at a single card/social expression printing system site or at a number of card printing system sites, as shown in FIG. 28, that print social expression items/cards in response to card identification and personalization information received through one or more computerized data networks.

According to embodiments, any time a potential orderer on a networked device 232, such as a mobile device, networked computer, laptop, or tablet, etc. makes a request, the browser can evaluate information provided by the networked device 232. For example, mobile browsers and other applications are capable of providing programming interfaces into the social expression item/card ordering website. In accordance with certain embodiments, information stored locally on the electronic networked device 232, such as browser cookies and cache, is used to select (order) the social expression item/card to gift orderer's. For example, the information stored locally on a networked device 232 may reflect the social expression item/card order's tap behavior. This information can be interrogated by the web browser, and the result of the interrogation is fetching predetermine web address URL and rendering predetermined HTML code. For instance, when a gift orderer taps or inputs identification information on an item with their networked device 232 and the device provides no local information (e.g., this could be a first tap), then electronic device's browser fetches a default mobile web site. This web site will be stored on the networked device 232 to be used for future orders.

Next the gift recipient taps and icon for a digital gift item 124, the stored website is rendered as a splash page to present something locally to the order's browser and the gift recipient while data is fetched from the network. This will give immediate feedback to the order upon taping an icon for a social expression item 124 and thus improve the orderer's experience. Thus, in the case of areas with poor network connectivity, the gift recipient 110 would be able to check-in to locations because the information would be stored locally on the native device. In some cases, when the network connectivity is restored, the check-in data can later be sent to the web server 4019.

The web server 4019 includes an operating system that provides executable program instructions for the general administration and operation of the web server 4019, and it may further include computer-readable medium storing instructions that, when executed by a processor of the web server 4019, allow the web server 4019 to perform its intended functions. Suitable implementations for the operating system and general functionality of the web servers are known or commercially available, and are readily implemented by persons having ordinary skill in the art, particularly in light of the disclosure herein.

The card ordering environment 4019 in one embodiment is a distributed website computing environment utilizing several computer systems and components that are interconnected via communication links, using one or more computer networks or direct connections. However, it will be appreciated by those of ordinary skill in the art that such a website system could operate equally well in a system having fewer or a greater number of components than are illustrated in the figures. Thus, the depiction of the environment should be taken as being illustrative in nature, and not limiting to the scope of the disclosure.

The environment may include additional components and/or other arrangements. In this example, the system 518 includes an order manager that responds to requests from the orderer's devices 4019 to provide the network devices 4019 with ordering options/information concerning social expression items/cards 124. In some embodiments, the digital gift file manager is an application executed on the web server 4019. The order file manager can be launched, viewed, and/or controlled using the networked devices 4019, via the web browser window.

Turning to FIGS. 21 and 22A-22B, in preparing the card description database each original social expression item/card 124 is viewed and assigned an alphanumeric code to identify each unique card. For example, card number 150 may be licensed and published from a specific artist or card creation source. If original art images (i.e. images created using artistic media including computer paint programs) are being used, card numbers are assigned serially to each submission from an artist or other source. A three-letter publisher code is assigned to each artist or publisher the publisher (“publisher code”). For example, “XYZ Cards” for a favored card creation source.

The card/social expression item 124 is then named using the publisher code followed by one or more numerals (“card name”). For example, the card name for card number 150 published by favored publisher XYZ Cards is XYZ0150. Each image on the original card (“original card image”) including the front panel (or page), inside panel (or page) and back panel (or page) images, is named with the card name followed by a number indicating the order in which the image appears on the card (“image name”). For example, XYZ01501 would be the image name for the first image on card number 150 published by XYZ Cards.

Typically, original digitally created art images or digital photographic images will be used in the creation of the cards/social expression items. The digital art can be created on any commercial graphic arts program, (e.g., Adobe Photo Shop Elements, Adobe InDesign) and the image can be created by utilizing any commercial quality digital photography equipment and processed using commercial photo editing programs (Adobe Photo Shop).

Any image that appears in the same location on more than one card (“repeated image”), such as a logotype, is named with the publisher code followed by a four-letter code and a single numeral indicating the order in which the repeated image appears on the card relative to other repeated images on the same card (“repeated image name”). For example, XYZLOGO is the repeated image name for the first repeated image to appear on card number 150 published by XYZ Cards.

Images for use in cards/social expression items 124 are saved in two different formats, (1) a print image file which can be processed to create files which can be used by a color printer to create the social expression item 124 (or card) and (2) a display image file which can be displayed on a color monitor to assist in the ordering of card/social expression item 124. The print image file is saved to the hard drive in a color image file format such as TIF, PNG or JPG. In addition, if a minimum amount of memory space is to be used, the file can be compressed using, for example, the Lempel-Zev and Welch (LZW) compression algorithm. The file is identified with the image name followed by the extension. TIF (“Print image file name”). For example, XYZ01501.PNG is the print image file name for the first print image on card number 150 published by XYZ Cards images. The print image files are typically saved to a separate directory.

The hue and saturation of palette colors associated with each print image file may need to be adjusted to new values (i.e., color corrected) so the printed output will match the colors envisioned for the card/social expression images or original art as printed on the social expression item/card 124. This is accomplished with a color correction program, such as (Adobe InDesign or Adobe Illustrator available at Adobe.com) which generates new palette colors by automatically applying red, green, and blue color correction curves to each color in the indexed color image palette. The details of color correction are well known in the art and therefore need not be explained here.

If a scanned image or graphics is incorporated into a card or social expression item, dithered print image file may be used, which is identified with the image name followed by the extension .PCD (“dithered print image file name”). For example, XYZ01051.PCD is the dithered print image file name for the first dithered print image on card number 150 published by XYZ Images. Dithered print image files are then compressed using the LZW compression algorithm and saved in a proprietary format To provide rapid retrieval from a large number of dithered print image files, dithered print image files are moved from the dithered images directory to a number of nested directories using a software program which automatically relocates the files (“image file placement program”). This can be accomplished by using a program such as PHOTODEMON available at photodemon.org.

The display image file is created from this display image. The displayed size of display images is determined by their resolution, therefore, the display image resolution must be adjusted to provide a displayed image which may be easily viewed on a range of monitor and television screen sizes. For example, the resolution available on a typical monitor or typically in the range of 1280×720, 1920×1080, or 3840×2160 pixels. At this resolution on a 24-inch monitor screen, for a display image to appear at approximately the same size as a printed image created with a dithered print image file, the display image must have a resolution of at least 200 dpi. An about 200 dpi display image can be created from the 600 dpi print image in Irfan View by selecting “Resample” from the Transform menu and entering the resolution desired.

When the display image is saved it is processed by a palette normalization program, such as Irfan Paint, which analyzes the color palette associated with each display image and transforms it into a palette having certain colors in specific palette locations (“standard color palette”). For example, red, green, blue, cyan, magenta, yellow, black and white are located in the first through eighth palette locations. The resulting file is then compressed using the LZW compression algorithm and saved in a proprietary format (“standard display image file”). The file is identified with the image name followed by the extension .JPG (“standard display image file name”). For example, DMF01501.JPG is the standard display image file name for the first display image on card number 150 published by XYZ Images. To provide rapid retrieval from a large number of display image files, display image files are moved from the display images directory to a number of separate directories using a software program which automatically relocates the files (“image file placement program”). This can be accomplished by using a program such as Zoner Photo Studio Free.

Two additional types of files which are created are print font files and display font files. A font is defined as a set size bitmap of a particular typeface. The resolution of print fonts must match the resolution of a particular printer (e.g., 1200 dpi for the Noritsul D1005HR color printer). The displayed size of display fonts is determined by their resolution; therefore, the display font resolution must be adjusted to provide a displayed font which may be easily viewed on a range of monitor and television screen sizes. For example, the resolution of a typical monitor ranges from above 720, 1080, etc. pixels. At this resolution on a 24-inch television screen, for a display font to appear at approximately the same size as a print font, the display font must have a resolution of at least 200 dpi.

A six-letter code is assigned the font (“font code”). For example, the font code for XYZ Fonts is XYZFNT. Each point size of the font is named by the font code followed by two numerals (“font name”). For example, the font name for 14-point XYZ Fonts is XYZFNT14. Print font files are identified with the font name followed by the extension 0.300 (“print font file name”). For example, XYZFNT14.300 is the print font file name for 14-point XYZ Fonts. Display font files are identified with the font name followed by the extension 0.085 (“display font file name”). For example, XYZFNT14.085 is the display font file name for 14-point XYZ Fonts.

Print fonts and display fonts can be created using a scaleable font library, such as those found at the Font/font.com website. Typeface Library and a font conversion program, such as TRANSTYPE4 (Fontlab Ltd., Millersville, Md.) may also be used to create the social expression items 124. Both print font files and display font files are saved to a directory named “Fonts” on the hard disk in the memory system memory storage.

To provide rapid retrieval from a large number of font files, both display and print font files are moved from the fonts directory to a number of nested directories using a software program which automatically relocates the files (“font file placement program”). This can be accomplished by using a program such as Fontspring for PC and Anyfont for IDS computers. For example, when the font file placement program is run, the print font File XYZFNT14.300 and the display font file HOWLSS14.085 are automatically transferred from the fonts directory to a separate subdirectory.

Print images, display images and text used in a social expression card format must be positioned on the front, inside, or back panels (or pages) of the social expression card using a software program with this capability (“card layout program”). This can be accomplished with a program such as Print Artist®25 Plantinum. For example, card number 150 published by XYZ would be formatted using the Print Artist software program by (1) selecting “image” from a menu. (2) The card name XYZ0150 is entered. (3) The Print Artist® program allows the order of the social expression item 124 to set the size of the social expression item 124, for example four and one-half inches by six and one-half inches, the card format can also be designated as horizontal or vertical. (4) The desired panel (or page) for image placement is selected (“F” for front panel, “I” for inside panel or “B” for back panel). (5) The image name XYZ01501 is entered (the first image on the front panel). (6) The image position is entered (“C” for center of panel, “T” for top of panel, “B” for bottom of panel, “L” for left side of panel, “R” for right side of panel, or specific x and y coordinates are entered). Positioning of the first image would be completed at this point. Additional images are positioned by repeating steps four through six.

Text is entered and positioned on the social expression card format by (1) selecting “Text” from a menu. (2) Selecting the panel (or page) on which the text is to be placed. (3) Entering the text position by selecting “C” for center of panel, “T” top of panel, “B” bottom of panel, “L” left side of panel, “R” right side of panel, or by entering specific x and y coordinates. (4) Selecting the text font and point size from a list of fonts and point sizes. For example, 1035 Avon Book, 16-point. (5) Selecting the text color from a list of available colors. For example, black, white, red, blue, magenta, green, or cyan. (6) Entering the text, for example “Happy Anniversary”, using the keyboard 4017.

If an area for personalized text 4072 to be retrieved from an order information database constructed from data received through electronic communication means, is to be specified, this is accomplished by (1) choosing “Personalized Text” from a menu. (2) Selecting the panel where personalized text is to be placed. (3) Entering the text position by selecting “C” for center of panel, “T” for top of panel, “B” for bottom of panel, “L” for left side of panel, “R” for right side of panel, or by entering specific x and y coordinates. (4) Selecting the text font and point size from a list of fonts and point sizes (e.g. 1318 Howard Thin, 14 point). (5) Selecting the text color from a list of available colors (e.g. black, white, red, blue, magenta, green, or cyan). (6) Entering the number of lines of personalized text to be allowed (e.g. six lines). The card/item printing system control program determines, at the time user text is retrieved from the order information database, how many characters can be placed on each line given the font specified in the card description database.

An area or field for a personalized image 4073, such as a signature or a picture of the card purchaser, retrieved from an order information database constructed from data received through a computer network or telecommunications means, may be automatically positioned in a specified relationship to other card components, for example, a personalized image 4073 may be positioned one-quarter of an inch below a text area or personalized text area on the inside panel (or page) of all cards.

The front, inside, and back card panels, item panels, clothing surface (front, back, sleeves, etc.) (or pages) are individually viewed on the monitor display 4018 to assure that images and text are properly positioned. If modifications are required, the appropriate steps are repeated. Card and item formats created by the card layout program are automatically saved under the card name to a database (“card description database”). Each card or item in the card/item description database is defined in terms of its components, such as images, text, and personalization fields for either text or images.

Next, the purchaser selects the digital gift 125 to provide along with the social expression item 124. As set forth above, the digital gift 125 may be one or more of the following types of digital files: literature, visual arts, stock audio, stock video, custom audio, photographic, custom video, stock audio/visual, custom audio/visual, music files. As discussed above, the digital gift 125 can be customized digital files generated by the social expression gift giver 109, e.g., gift giver 109 generated digital audio, audio-visual, image, or video files that stored in the digital gift data storage. Each digital gift 125 is provided with a unique digital gift code. For example, a digital image file created by XYZ Cards could be coded XYZA1. Each digital gift 125 is also associated with a unique QR code 123, which along with providing instructions and applications for operation and retrieval of the digital gift 125 via the digital gift retrieval code. The device 102 of the gift recipient 110 further includes the unique digital gift code associated with the digital gift 125.

Each gift giver 109 that creates a custom digital gift 125c is given a unique digital gift identifier code. The gift giver 109 is given the option to create a security code to limit the distribution of the custom digital gift 125c to prevent unauthorized publication of custom digital gifts 125c including personal information to the internet or other mass means of publication or republication. The gift giver 109 is also given the option to allow unlimited republication of the custom digital gift 125c. The digital gift giver 109 is also given the option to store the custom digital gift 125c on the data storage of the web portal as well as providing an option for the digital gift recipient 110 to store or download the custom digital gift 125c. Data storage options for the custom digital gift 125c the gift recipient 110 may be given the option to rent long term storage for one or more custom digital gifts 125c for later on-demand retrieval by authorized digital gift recipients 110 and the gift giver 109.

One preferred method of retrieving card images for display and selection by prospective card purchasers is through a series of social expression item 124 parameter screen displays that allow the prospective social expression item orderer, in response to a displayed or otherwise presented question or prompt, to describe in a progressive manner, through selection or input of a series of words, phrases or icons (“card parameters”), the type of social expression item 124 desired. For example, the social expression item124 orderer may first be asked to select or input a general class of social expression items, such as “Birthday”, “Anniversary”, “Get Well”, etc. In certain embodiments of the invention, the prospective social expression orderer may be either a category buyer from a social expression item wholesaler or retailer that orders cards in bulk for resale to gift giver 109. The prospective social expression orderer may also be an individual gift giver 109 that selects a stock digital gift 125 or uploads a user generated digital gift 125c. If “Birthday” is selected or input, the prospective card purchaser is then prompted to select or input a sub-classification of birthday cards, such as “Relative”, “Children”, or “Humorous.” This process continues to prompt the prospective social expression item orderer to select or input social expression item parameters until the last sub-classification of social expression items is reached. Upon selection of a general class of cards or an associated sub-classification, one or more card images associated with the general class of social expression items or an associated sub-classification are retrieved and displayed on the display device. Such social expression item displays may take a variety of formats, for example, social expression images may be displayed sequentially or in sequential groups of two or more social expression images. These social expression image displays may optionally include card identification names (or codes) associated with individual social expression item images.

In one embodiment, a menu is created that allows rapid retrieval of social expression item images using a software program (“menu layout program”) capable of constructing a multilevel menu display (“menu screen”). One or more social expression item parameters displayed on the menu screen may each be linked to other subordinate or secondary card parameters that are also displayed on the menu screen. These secondary card parameters can, in turn, be linked to other levels of additional parameters. Every card parameter may be linked to one or more groups of card names that can be used to retrieve card designs to be displayed to the prospective card orderer. Print Artist® Plantinum 25 is such a program (Nova Development). In the Print Artist® program, a menu screen is created in a menu creation mode, in which a social expression item parameter's text is entered and then displayed in one of several menus. The menus containing social expression parameter text are displayed next to each other. Social expression item parameters may be displayed on a menu screen in a variety of formats. For example, each social expression item parameter may be displayed in one of several adjacent menus within the menu screen.

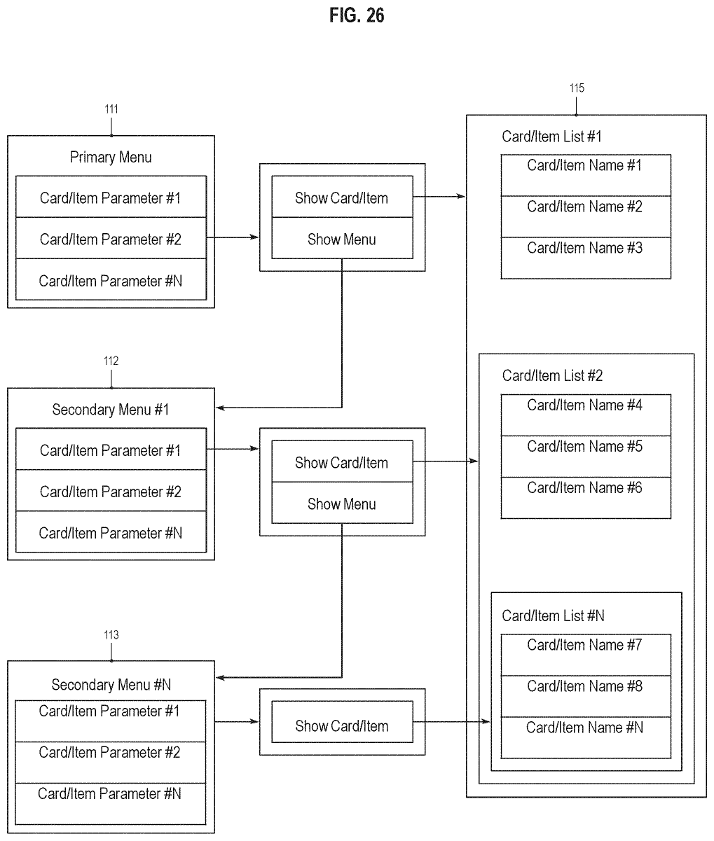

After the first menu (primary menu) has been completed (see FIG. 26), a number of secondary menus, can be created in the menu creation mode by selecting a social expression item parameter which appears on the primary menu and inputting one or more subordinate social expression item parameters. A secondary menu is always linked to a social expression item parameter displayed in a higher level menu.

After one or more secondary menu linked to higher level social expression item parameters have been created, card lists 4015 are created. This may be accomplished in the Print Artist® program when a menu parameter is selected. A social expression list window is displayed next to the primary and secondary menus. Social expression item names of items to be displayed in association with a selected social expression item parameter are entered in the order in which they are to be displayed (social expression item list window). Any time after social expression item names are entered, the order in which they will be displayed can be changed.

Social expression item parameters can be deleted from menu creation screens and card names from the card list by: (1) selecting the social expression item parameter or social expression item name; and (2) pressing the “Delete” key on the keyboard. The file created using the menu layout program (social expression parameter database) is automatically saved to the hard disk.

After these databases have been prepared by the computer system, this data (possibly excluding the card parameter database) must be transferred to either a memory storage means which may be accessed directly, for example, through a network. Certain of the databases (the standard display image files, display font files, card description database, and card parameter database) may also be distributed through a digital network, or directly to individual potential social expression item orderer, bulk buyers for wholesalers or retailers, or other sites for use with a variety of social expression item image display means, such as smart phones, tablets, personal computers, or interactive video systems.

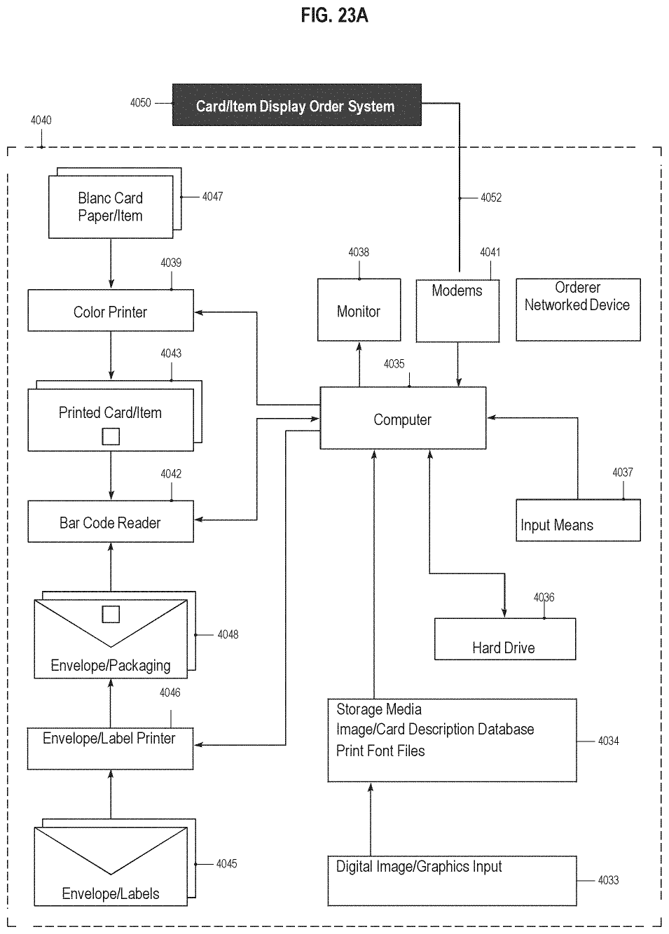

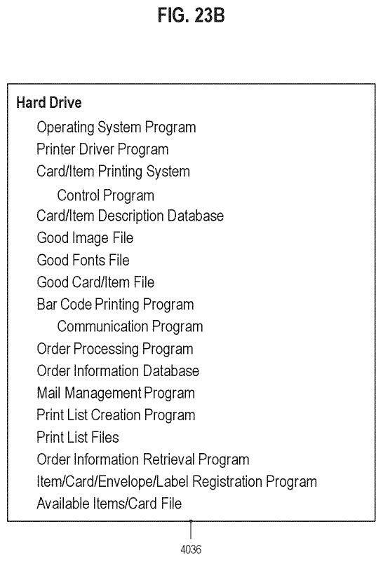

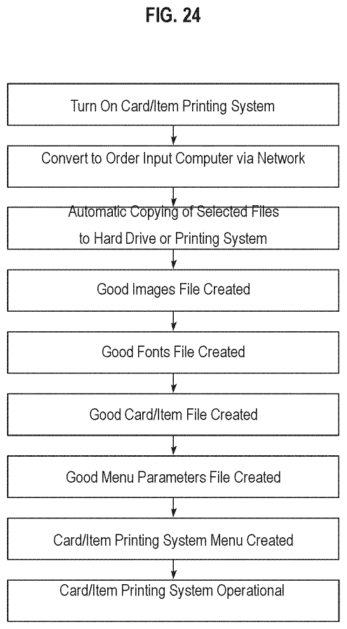

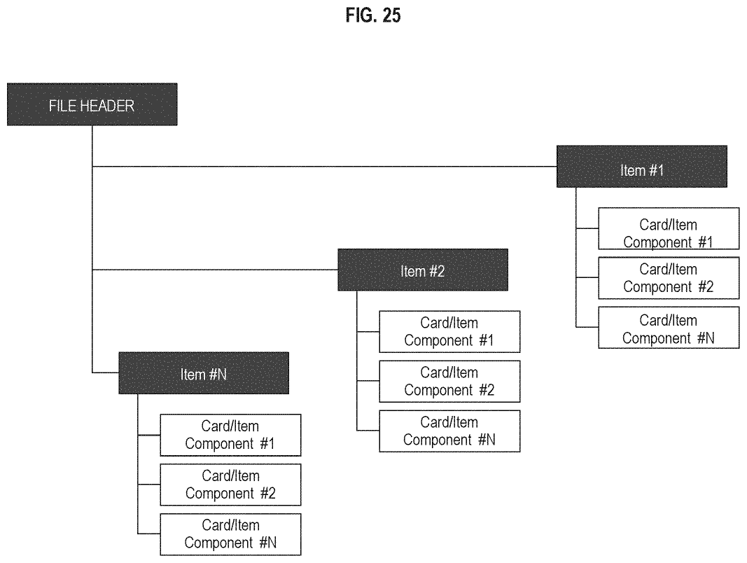

In one preferred embodiment, shown in FIGS. 23A-23B, each card printing system 4040 comprises a computer system which, for example, includes (1) a desktop computer 4035 (CPU) with a large quantity of RAM, for example, eight gigabytes, (2) a hard disk 4036, (3) a graphics adapter card, (4) a color monitor 4038, (5) an input means 4037, input means such as a mouse, track box, touchpad or touch screen, (6) a color printer 4039, (7) a direct memory access printer interface card, (8) one or more network connection devices. In the preferred embodiment shown in FIGS. 23A-23B, the computer system hard drive 4036 in the social expression item printing system contains (1) an operating system program, (2) a printer driver program, (3) a social expression item printing system control program, (4) a communication program to transmit and receive orders, (5) an order information database, (6) an order processing program, (7) a print list creation program, (8) one or more print list files, (9) an order information retrieval program, (10) a social expression/envelope/label registration program which registers successfully printed social expression items and the date on which the social expression items were mailed, (11) a mail management program, (12) a social expression item description database, (13) a good images file, (14) a good fonts file, (15) a good cards file, and (16) an available cards file.

FIG. 23A shows, alternatively, a number of social expression item printing systems in a networked configuration. The social expression item printing systems in this configuration has a network card attached over a network interconnection means 4064 and through a second network card, to a network server system 4061, consisting of a computer 4049 which is attached to one or more large capacity memory devices 4036. Each social expression item printing system 4040 receives order information for processing from card order systems 4050 over the internet or private network means 4052, for example, a virtual private network internet connection.

Other networked configurations are possible, for example, a configuration which contains one or more social expression item printing systems each with a CD-ROM drive and a network card. The social expression item printing systems in this configuration are in turn attached to a server computer system which includes one or more large capacity memory devices, such as a hard drive.

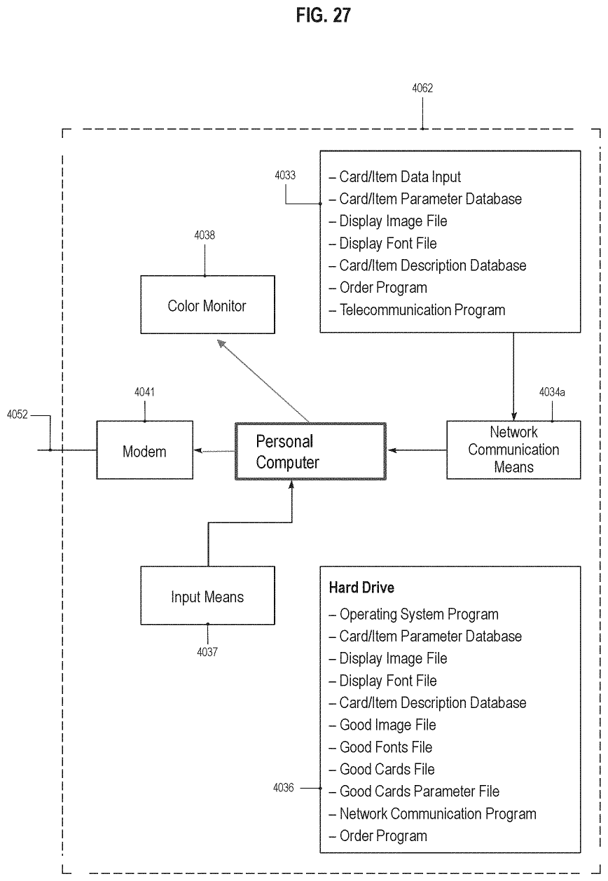

As shown in FIG. 27, the social expression item printing system control program on the social expression item printing system's hard disk drive 4036 or a hard drive which is part of a network server system, analyzes the card descriptions contained in the card description database and the dithered print image files and print font files present on the hard drive and creates three files: (1) a file indicating which print images files are present (“good images file”), (2) a file indicating which print font files are present (“good font files”), (3) a file indicating which card formats in the social expression item description database have all the files present that are necessary to print cards (“good card file”). The social expression item printing system is then operational.

Social expression item orderers may originate card orders at card display/order sites using card display/order systems 4050. In one preferred embodiment, the card display/order system 4050 requires a customer to select a card design from a card display, enter order information on an order form 4051 and then transmit the order information over a telecommunication line 4052 to a card printing system site 4054, from a card display/order site using, for example, an internet connection.

Customers may view social expression item images using a personal computer system 4062, or other interactive information display systems.

Card images may be selected for display by customers using, for example, a displayed menu which allows the prospective card purchaser to describe the type of social expression card desired. Methods other than the use of a menu to select a desired type of card from available card images, may also be used.

A card display/order system may include an internet connection 4041 which allows a customer to place an order by using a keyboard or other input means connected to a computing means to enter order information by, for example, responding to displayed prompts which request that various items of order information be entered by the customer. The computing means is a personal computer 4057or may alternately be a smart phone or tablet computer. The order information preferably is entered by a customer in an interactive real-time manner via a series of display prompts via the web portal.

Methods of processing orders may vary depending on the order processing program used, for example, the program Ship Station, processes orders received as a digital file from internet by displaying an image of a monitor along with blank data entry fields. The user visually examines the displayed image and enters the displayed order information in appropriate data entry fields. After all order information is entered, the user selects the “save” function which causes the program to save the order information entered in the data entry fields to the order information database. In addition, a properly sized and formatted personalized image (“signature image”) is also saved from the input data and is logically connected to the correct card order number 4074 in the order information database 4070. The saved signature image may be saved in any number of standard image file formats, such as PNG, JPG or TIF, as well as proprietary image file formats. Optionally, if the card destination address 4075 zip code stored in the order information database 4070 matches a zip code stored on a hard drive 4036 in a file which lists zip codes in association with remote social expression item printing system sites (“printing site zip code list”), the order information may be automatically transmitted by the social expression item printing system computer 4035 at the site which received the original social expression item order, using an internet connection 4041 attached to telecommunications means 4052, to a social expression item printing system site listed on the printing site zip code list.

Order information indicating when an ordered social expression item is to be delivered 4082 is retrieved from the order information database 4070 and lists of social expression items (or orders) to be printed on specific dates (“print list files”) 4079 are automatically created by a program such as CFXlist (Onkor, Ltd.). The CFXlist program determines a printing date based on a social expression item delivery date specified by a customer in an order. If no date is specified, the current date is used. The social expression item order code (or number) of any social expression item order that has not been printed and has a customer specified delivery date which is on or before the current date is automatically listed by CFXlist in a daily print file named CFXLIST.OUT (“print list file”). At a specified time each day, active social expression item printing systems run a program, such as Ship Station®, which retrieves order information 4071 from the order information database 4070 for those social expression item orders 4080 listed in the current date print list file Y79. The QR code 123 that is linked to the digital gift 125 is preferably printed onto the penultimate or last page of the social expression item or other portion of the social expression item 124. Then it calls a program which prints each ordered card on blank card paper 4047, including a bar code 4044 on the back card panel (or page). The bar code, which is generated by a bar code program such as Zint® Barcode Generator, represents the unique card order number (or code) for the social expression item printed.

When a social expression item is successfully printed, this is recorded in the social expression item's order information in the order information database (“completed”). Completion can be accomplished several ways. One method is to run a program on a computer 4035 with a bar code reader 4042, for example, a SOK Barcode Scanner attached to the computer's input means 4037. The bar code reader 4042 may be used to read the bar code 4044 on the back panel (or page) of a printed card 4043, the card's order information 4081 in the order information database 4070 is updated to indicate the ordered card corresponding to the social expression item order code has been successfully printed. Successful registration automatically causes Ship Station® to query the portion of the card's order information 4071 in the order information database 4070 for envelope color 4087 and envelope addressing information 4075, 4083, 4084. Address information retrieved is printed on a blank envelope 4045 of the specified color 4087, along with a code 4044, for example a bar code, representing the social expression item order code, using a printer 4046, for example, a Ricoh PSI 36556A. A printed social expression item 4043 may then be matched with the correct printed envelope 4048 by using, for example, either a single bar code reader 4042 to sequentially read the bar code on the rear social expression item panel and the bar code on the envelope or by using two bar code readers to simultaneously read both bar codes. If the bar codes on the printed social expression item and printed envelope are identical, a signal, for example a distinctive audible tone, is output by the computer 4035 indicating that the social expression item 124 should be inserted in the envelope and the social expression item's order information 4071 in the order information database 4070 is updated to indicate the social; expression item 124 order has been successfully processed 4085 and the date the processing was completed 4086.

In an alternative embodiment of the present invention in the card description database, display image files, display font files, card parameter database, and order program are stored at a server that may be separate from the social expression item display/order system 4050 and the social expression item printing system 4054. For example, the server 4022 can be a node on a local area network (LAN), wide area network (WAN), or the Internet that is accessible by social expression display/order system 4050 and social expression item printing system 4054.

The specific implementation is based on access via the Internet. The card display/order system 4050 has the same general configuration as previously discussed. However, the memory 4023 for the social expression item display/order system 4050 does not include a card description database, display image file, display font file, card parameter database, or order program. Instead, an Internet browser program, such as Internet Explorer (Microsoft Corp., Redmond, Wash.), or Google Chrome is installed to access such software over the Internet. Because of the small size of the programs required at the card display/order system 4050, the memory 4023 need not be a hard disk, but may be any of the many forms of solid state random access memory that are currently available.

Using the Internet browser software, the social expression item display/order system 4050 accesses the Internet server 4022 through an Internet service provider 4020. At the Internet server 4022, there is a large capacity memory device 4036 that contains all the software necessary to display cards and accept orders, in addition to programs normally found on such sites. Included in this software are, for example, a social expression item description database, display image file, display font file, social expression item parameter database, order program, and order information database. These programs enable the user of the social expression item display/order system 4050 to select, view, and order social expression social expression items using the Internet browser software.

Orders transmitted to an Internet server 4022 may be automatically transferred to a social expression item printing system site 4054 or stored for later retrieval from the Internet server 4022 by the card printing system 4054. A number of possible computer network or telecommunications links can be used between the social expression item printing system site 4054 and the Internet server 4022. For example, a broadband telecommunications link 4024, such as a T1, T3, or ISDN line can be used to connect the Internet server 4022 to a network access point 4021. Alternatively, a direct telecommunications line 4052 (e.g., a standard telephone line) can be used to connect the card printing system 4054 to an Internet server 4022.

The above disclosure sets forth a number of embodiments of the present invention. Other arrangements or embodiments, not precisely set forth, could be practiced under the teachings of the present invention.

1. A social expression item for use in conjunction with a recipient's electronic device comprising:
a. a social expression item having an item body, wherein the social expression item is a postcard or a gift card made of paper or plastic;
b. a social expression message portion located on the item body;
c. a social expression message printed on the social expression message portion of the item body; and
d. a digital gift retrieval code located on the item body, the digital gift retrieval code including instructions for accessing a remote digital storage system and a digital gift file identifier, the digital gift retrieval code being readable by a recipient's electronic device, the gift retrieval code including digital instructions which allow the recipient's electronic device to access a remote digital data storage system, the data storage system storing a digital published content identified by the digital gift file identifier for retrieval and display of the digital gift file on the recipient's electronic device.

2. The printed social expression item of claim 1, wherein the social expression item further comprises at least one of a graphic element, a design element, and a photographic element located on the social expression message portion of the social expression item.

3. The printed social expression item of claim 1, wherein the digital gift retrieval code is a QR code.

4. The social expression item of claim 1, wherein the digital published content is a digital literature file, a digital visual art file, a digital audio file, a digital stock audio file, a digital stock video file, a custom digital audio file uploaded by the card giver, or a custom digital video vile uploaded by the card giver.

5. The social expression item of claim 1, wherein the social greeting message portion includes both a printed stock social expression message and a card giver generated personal message subsection.

6. The social expression item of claim 1, wherein the card giver generated personal message subsection is electronically input and printed at the same time the social expression message is written on the social expression item.

7. A method of ordering and manufacturing a novel greeting card having a digital retrieval code for retrieval of a digital gift file, the method comprising the steps of:
a. accessing a computer and directing the computer to connect with a computerized printed greeting card ordering system;
b. displaying a plurality of stock greeting card choices, each of the stock greeting card choices being associated with at a digital gift representing published content for retrieval by the gift card recipient after receipt of the card;
c. selecting at least one greeting card from the plurality of stock card choices;
d. composing a personal message directed to the card recipient;
e. selecting a digital gift from all digital gifts associated with the selected card;
f. storing the personal message, selected stock card, and an identifier of the selected associated digital gift in memory component associated with the greeting card ordering system;
g. printing the stock card on paper or plastic, including the personal message on a first portion of the card; and
h. printing a digital gift retrieval code encoding for the selected associated digital gift on a second portion of the card.

8. The method of claim 7, further comprising the step of providing a delivery address for the recipient of the card.

9. The method of claim 8, further comprising the steps of inserting the printed greeting card into a printed delivery envelope and causing the printed delivery envelope with inserted card to be delivered to the card recipient.

10. The method of claim 8, further comprising the steps of providing a server connected to the memory component of the greeting card ordering system, a card printer component, and an envelope printing component and further comprising the step of causing the server to send a print command to the card printer component and envelope printing component.

11. The method of claim 8 wherein the process further comprises the step of printing a delivery envelope including a delivery address retrieved from the memory component.

12. The method of claim 7 wherein the delivery facilitation member is one of at least a delivery envelope, a delivery label, or social expression item product packaging.

13. A method of retrieving a digital gift encoded on a social expression item, the method comprising the steps of:
a. receiving a paper or plastic postcard or greeting card having a digital gift retrieval code thereon which provides electronic access to a digital gift file representing published content;
b. causing an electronic device to read the digital gift retrieval code located on the social expression item;
c. decoding instructions encoded in the digital gift retrieval code to transmit an electronic signal to a website which provides the electronic device with access to an electronically retrievable digital gift file;
d. decoding the digital gift identifier from the digital gift retrieval code;
e. searching the memory component associated with the website for the digital gift file identified by the digital gift identifier of the digital gift retrieval code; and
f. displaying the published content on the recipient's electronic device.

14. The method of claim 14, wherein the published content includes an ebook, a musical work or a video.

15. The method of claim 13, further comprising the steps of uploading a custom digital gift file created by the card giver to the memory component of the website, creating a unique digital gift retrieval code identifying the uploaded card giver created digital gift file, and causing the unique digital gift retrieval code identifying the uploaded card giver created digital gift file to be printed on a social expression item.

16. The method of claim 13, the machine readable digital gift retrieval code is preferably a QR code printed on the greeting card.

17. The method of claim 13, the method further comprising the step of downloading the digital gift file to a gift recipient's hand digital device or to another digital device owned by the recipient.

18. The method of claim 13, wherein the step of displaying the digital gift file includes playing a digital audio or video file on the recipient's electronic device.

19. The method of claim 13, wherein the social expression item is one of at least a greeting card, a clothing item, food product packaging, and a party good having a digital gift retrieval code printed thereon.
